(19) United States
(12) Patent Application Publication
(10) Pub. No.: US 2025/0355379 A1
(43) Pub. Date: Nov. 20, 2025

(54) ELECTROSTATIC CHARGE IMAGE DEVELOPING TONER, METHOD FOR PRODUCING ELECTROSTATIC CHARGE IMAGE DEVELOPING TONER, IMAGE FORMING METHOD, AND IMAGE-FORMED PRODUCT

(71) Applicant: Konica Minolta, Inc., Tokyo (JP)

(72) Inventors: Ami MOTOHASHI, Tokyo (JP); Junya UEDA, Tokyo (JP)

(21) Appl. No.: 19/197,132

(22) Filed: May 2, 2025

(30) Foreign Application Priority Data
May 16, 2024 (JP) 2024-080341

(51) Int. Cl. G03G 9/087; G03G 9/08

(52) U.S. Cl. CPC G03G 9/08711; G03G 9/0804; G03G 9/08755

(57) ABSTRACT

Provided is an electrostatic charge image developing toner including toner base particles containing a binder resin. The binder resin contains a styrene-(meth)acrylic resin and a polyester. A mass ratio of the styrene-(meth)acrylic resin to the polyester is in a range of 80:20 to 1:99. The electrostatic charge image developing toner is used for forming an image on a recording medium that is long and has an air permeance of 20,000 sec or more at a temperature of 25° C. and a pressure of 49.03 hPa.

### CROSS-REFERENCE TO RELATED APPLICATIONS

The entire disclosure of Japanese Patent Application No. 2024-080341, filed on May 16, 2024, is incorporated herein by reference in its entirety.

### BACKGROUND OF THE INVENTION

### Technical Field

The present invention relates to an electrostatic charge image developing toner, a method for producing an electrostatic charge image developing toner, an image forming method, and an image-formed product.

### Description of Related Art

In recent years, recording media have been increasingly diversified in the field of electrophotography. Among these, developments are underway in printing labels and packaging materials using resin films as recording media (JP 2019-203964 A and JP 2022-054448 A).

### SUMMARY OF THE INVENTION

Above all, in a case where the recording medium is long, the recording medium after image formation, i.e., an image-formed product, is wound and stored in a roll shape and is pulled out at the time of use. It has been found that, when the image-formed product is pulled out from the roll, a blocking phenomenon in which the toner is peeled off tends to occur.

The present invention has been made in consideration of the above-described problems and circumstances, and an object to be achieved by the present invention is to provide an electrostatic charge image developing toner or the like in which the blocking phenomenon is reduced.

To achieve the object, the present inventors have studied the causes and the like of the above problems. In an electrostatic charge image developing toner including toner base particles containing a binder resin, the binder resin contains a styrene-(meth)acrylic resin and a polyester in a specific mass ratio range. The electrostatic charge image developing toner is used for forming an image on a recording medium that is long and has an air permeance of 20,000 sec or more at a temperature of 25° C. and a pressure of 49.03 hPa. The present inventors have found that, with these configurations, the blocking phenomenon can be reduced in the electrostatic charge image developing toner, and have completed the present invention.

To achieve at least one of the abovementioned objects, according to an aspect of the present invention, an electrostatic charge image developing toner includes toner base particles containing a binder resin, wherein
the binder resin contains a styrene-(meth)acrylic resin and a polyester,
a mass ratio of the styrene-(meth)acrylic resin to the polyester is in a range of 80:20 to 1:99, and
the electrostatic charge image developing toner is used for forming an image on a recording medium that is long and has an air permeance of 20,000 sec or more at a temperature of 25° C. and a pressure of 49.03 hPa.

Although the realization mechanism or action mechanism of the effect of the present invention is not clear, the inventors infer the mechanism as follows. Hereinafter, the electrostatic charge image developing toner is also simply referred to as a “toner”.

A long recording medium on which an image has been formed, i.e., an image-formed product, is wound into a roll and stored. Thereafter, the image-formed product is pulled out from the roll at the timing of using the image-formed product.

FIG. 1 is an explanatory diagram of a blocking phenomenon that occurs when an image-formed product is pulled out from a roll 300. FIG. 2 is a cross-sectional view of the image-formed product during the blocking phenomenon. As shown in FIGS. 1 and 2, when the image-formed product is pulled out from the roll 300, an offset toner 302 adheres to the surface (back surface) of a recording medium 303 opposite to the surface (front surface) on which a image layer 301 is formed, and a blocking phenomenon occurs.

FIG. 3 is a view of the image-formed product wound in a roll shape as seen from the center of the roll. When the image-formed product is wound into a roll and stored, an internal force of winding is applied to the image layer 301 as shown in FIG. 3. Thus, it is considered that the adhesive force between the recording medium and the image layer 301 is strengthened and the blocking phenomenon is more likely to occur.

FIG. 4 is an enlarged view of the image-formed product wound into a roll shape as viewed from the center of the roll. The recording medium 303 wound into a roll shape is electrostatically charged and is positively (+) charged. On the other hand, the image layer 301 is likely to be negatively (−) charged. As a result, an electrostatic attractive force is generated between the recording medium 303 and the image layer 301, and the blocking phenomenon is more likely to occur. Therefore, it is considered that the blocking phenomenon can be reduced by releasing the negative charges of the image layer to the outside of the image layer to reduce the residual charge amount.

In a recording medium having a relatively low air permeance value, that is, a recording medium in which permeability of air is high, air is unlikely to remain between the image layer and the recording medium during image formation, and a gap is unlikely to be formed between the image layer and the recording medium. Therefore, it is difficult to release the negative charge generated in the image layer to the outside of the image layer, and the residual charge amount is likely to be relatively large. On the other hand, in a recording medium having a relatively high air permeance value, that is, a recording medium in which permeability of air is low, air is likely to remain between the image layer and the recording medium during image formation, and a gap is likely to be formed between the image layer and the recording medium. Therefore, it is considered that the negative charge generated in the image layer can be easily released from the formed gap, and the residual charge amount can be made relatively small.

The image forming method according to the present embodiment uses a toner containing a styrene-(meth)acrylic resin and a polyester in a specific mass ratio as binder resins. Since polyesters have a large number of polar groups, a large amount of charge accumulated by charging is easily released to the outside of the toner, that is, the charge is easily attenuated. However, polyesters are likely to be negatively (−) charged by contact with a recording medium such as a resin film. When the contact charging amount is large, the residual charge amount is still large even if the charge is attenuated to some extent, and the electrostatic attractive force between the recording medium and the image layer is relatively strong. Thus, a styrene-(meth)acrylic resin that tends to be positively (+) charged with respect to a recording medium such as a resin film is used in combination. It is considered that, with this configuration, the maximum contact charging amount of the toner can be reduced, and the residual charge amount can be made relatively small, so that the blocking phenomenon can be reduced.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is an explanatory diagram of a blocking phenomenon that occurs when an image-formed product is pulled out from a roll;

FIG. 2 is a cross-sectional view of the image-formed product during the blocking phenomenon;

FIG. 3 is a view of the image-formed product wound in a roll shape as seen from the center of the roll;

FIG. 4 is an enlarged view of the image-formed product wound into a roll shape as viewed from the center of the roll;

FIG. 5 is a cross-sectional view of a film label after image formation;

FIG. 6 is a flowchart of steps (f1) to (f3) in a method for producing a toner;

FIG. 7 is a schematic cross-sectional view of an image forming apparatus of an electrophotographic method; and

FIG. 8 is a schematic cross-sectional view of the image-formed product in the thickness direction.

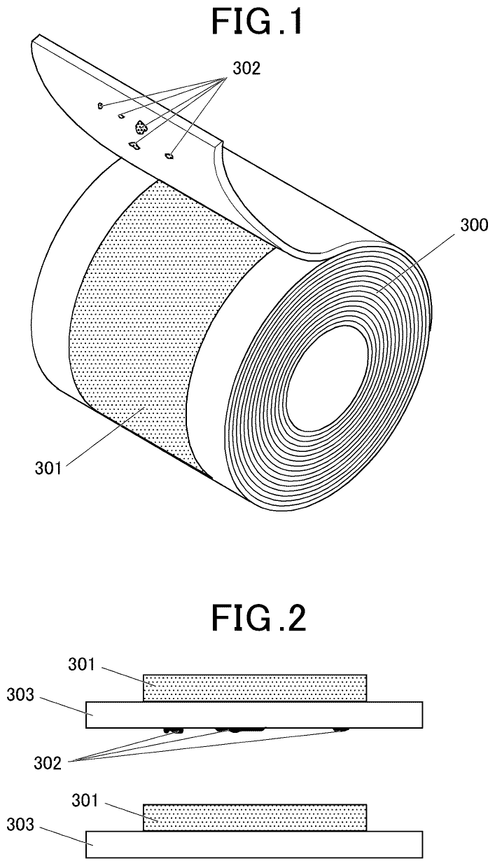

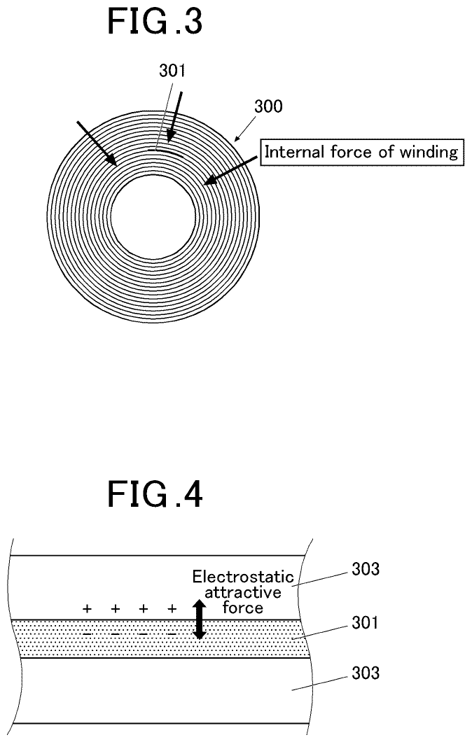

### DETAILED DESCRIPTION

Hereinafter, an embodiment of an analysis device, an analysis method, and a recording medium according to the present invention will be described. However, the scope of the invention is not limited to the illustrated examples.

The electrostatic charge image developing toner according to the present invention is characterized in that it is an electrostatic charge image developing toner comprising toner base particles containing a binder resin, wherein the binder resin contains a styrene-(meth)acrylic resin and a polyester, a mass ratio of the styrene-(meth)acrylic resin to the polyester is in a range of 80:20 to 1:99, and the electrostatic charge image developing toner is used for forming an image on a recording medium that is long and has an air permeance of 20,000 sec or more at a temperature of 25° C. and a pressure of 49.03 hPa.

This characteristic is a technical feature common to or corresponding to the following embodiments.

In an embodiment of the present invention, the styrene-(meth)acrylic resin is preferably positioned at the inner side of the toner base particles and the polyester is preferably positioned at the outer side of the toner base particles, from the viewpoint of reducing blocking.

In an embodiment of the present invention, the polyester is preferably not modified with a compound other than the monomer forming a repeating structure, and more preferably not modified with a styrene-(meth)acrylic resin, from the viewpoint of reducing blocking.

In an embodiment of the present invention, the styrene-(meth)acrylic resin preferably has a structure derived from methyl methacrylate, from the viewpoints of reducing blocking and improving abrasion resistance.

In an embodiment of the present invention, the mass ratio of the styrene-(meth)acrylic resin to the polyester is preferably in a range of 60:40 to 5:95, from the viewpoint of reducing blocking.

In an embodiment of the present invention, the content of the release agent is preferably 7% by mass or less with respect to the total mass of the toner base particles, from the viewpoint of reducing blocking.

In an embodiment of the present invention, the toner base particles are preferably an emulsion aggregate, from the viewpoint that the structure and shape of the toner base particles can be controlled.

In an embodiment of the present invention, a loss tangent T(70) at 70° C. obtained by dynamic viscoelasticity measurement is preferably in a range of 0.2 to 1.2, from the viewpoints of reducing blocking and improving low-temperature fixability and abrasion resistance.

In an embodiment of the present invention, the air permeance of the recording medium at a temperature of 25° C. and a pressure of 49.03 hPa is preferably 25,000 sec or more, from the viewpoint of a greater effect of reducing blocking.

In an embodiment of the present invention, the recording medium preferably contains at least one of polyethylene, polypropylene, and polyethylene terephthalate, from the viewpoint of a greater effect of reducing blocking.

The method for producing an electrostatic charge image developing toner according to the present invention is characterized in that it is a method for producing the electrostatic charge image developing toner described above, the method comprising: heating a dispersion liquid of styrene-(meth)acrylic resin particles to a temperature T [° C.] to grow particle size; mixing the dispersion liquid of styrene-(meth)acrylic resin particles at the temperature T [C] with a dispersion liquid of polyester particles while stirring; and holding the mixed liquid at the temperature T [C] for a certain period of time while stirring, wherein the temperature T [° C.] is higher than a glass transition temperature of the styrene-(meth)acrylic resin by a range of 30 to 40° C.

The image forming method according to the present invention is characterized by using the electrostatic charge image developing toner described above.

The image-formed product according to the present invention is characterized in that an image layer on a recording medium contains the electrostatic charge image developing toner described above.

In an embodiment of the present invention, it is preferable that the image layer has at least one void in a region having a width of 200 μm in a cross section in a thickness direction, from the viewpoint of reducing blocking.

Hereinafter, one or more embodiments of the present invention will be described with reference to the drawings. However, the scope of the present invention is not limited to the disclosed embodiments. In the present description, when two figures are used to indicate a range of value before and after “to”, these figures are included in the range as a lower limit value and an upper limit value.

### 1. Configuration of Electrostatic Charge Image Developing Toner

In the electrostatic charge image developing toner of the present embodiment, the binder resin contains a styrene-(meth)acrylic resin and a polyester. A mass ratio of the styrene-(meth)acrylic resin to the polyester is in a range of 80:20 to 1:99. The electrostatic charge image developing toner of the present embodiment is used for forming an image on a recording medium that is long and has an air permeance of 20,000 sec or more at 25° C.

In the present specification, the electrostatic charge image developing toner is also simply referred to as a “toner”. The toner includes toner base particles. An external additive is preferably attached to the surfaces of the toner base particles. The term “toner base particles” refers to particles that constitute the base of “toner particles”. When an external additive is added to the “toner base particles”, the resultant is referred to as a “toner particles”. The “toner” refers to an aggregate of the toner particles.

(1) Toner base particles

The “toner base particles” according to the present embodiment preferably contain, in addition to the binder resin, a coloring agent, a release agent, a charge control agent, and the like, if necessary.

The binder resin, the release agent, the coloring agent, and the charge control agent that are constituent components of the toner base particles are described below.

### (1.1) Binder Resin

When the toner base particles contain a binder resin, the toner can be fixed on a recording medium.

In the present embodiment, the binder resin contains a styrene-(meth)acrylic resin and a polyester resin. A mass ratio of the styrene-(meth)acrylic resin to the polyester resin is in a range of 80:20 to 1:99. The binder resin may contain another resin to the extent that the effects of the present invention are not impaired. The polyester may be a crystalline resin or an amorphous resin.

The polyester has many polar groups and easily releases charges in the toner to the outside of the toner. It is thus preferable that the polyester is positioned at the outer side of the toner base particles and the styrene-(meth)acrylic resin is positioned at the inner side of the toner base particles. The positions of the resins contained in the toner base particles can be confirmed by, for example, observing a cross section of the toner base particles.

### (Analysis Method of Resin Composition)

The composition of each resin contained in the toner base particles can be analyzed by, for example, pyrolysis gas chromatography/mass spectrometry (GC/MS).

Specifically, the amount can be determined by the standard addition method using a column and a detector that have been confirmed to be able to detect a monomer having a specific structure.

An example of detailed thermal decomposition conditions and GC/MS measurement conditions is given below.

### (Pyrolysis Conditions)

Measuring device: PY-2020iD (manufactured by Frontier Laboratories Ltd.)
Weight of measurement: 0.1 mg
Heating temperature: 550° C.
Heating time: 0.5 minutes

### (Measurement Conditions of GC/MS)

Measuring device: QP2010 (manufactured by Shimadzu Corporation)
Column: UltraALLOY-5 (inside diameter: 0.25 mm, length: 30 m, thickness: 0.25 μm, manufactured by Frontier Laboratories Ltd.)
Temperature increase range: 40° C. to 320° C. (held at 320° C.)
Temperature increase rate: 20° C./min

### (1.1.1) Amorphous Resin

In the present invention, the expression “exhibiting amorphousness” refers to having a glass transition temperature (Tg) but not having a melting point in an endothermic curve obtained by differential scanning calorimetry (DSC). That is, it means that there is no clear endothermic peak during temperature increase. The clear endothermic peak refers to an endothermic peak having a half width of 15° C. or less in an endothermic curve when the temperature is increased at a temperature increase rate of 10° C./min.

In the present embodiment, a styrene-(meth)acrylic resin is used as the amorphous resin. The polyester may also be amorphous. In addition, known amorphous resins such as vinyl resins other than the styrene-(meth)acrylic resin, polybutylene succinate, urethane resins, and urea resins may be used.

### (1.1.1.1) Styrene-(Meth)acrylic Resin

The styrene-(meth)acrylic resin can be synthesized by addition-polymerizing at least (a) a styrene-based monomer and (b) a (meth)acrylate-based monomer. Examples of the monomer include the following. If necessary, (c) other monomers may be further used.

### (a) Styrene-Based Monomer

In the present embodiment, the term “styrene-based monomer” includes, in addition to styrene represented by the structural formula of CH₂═CH—C₆H₅, monomers having a structure in which a known side chain or functional group is contained in the styrene structure.

Examples of the styrene-based monomer include monomers having a styrene structure, such as styrene, o-methylstyrene, m-methylstyrene, p-methylstyrene, «-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, and derivatives thereof. One of these may be contained alone, or two or more of these may be contained in combination.

### (b) (Meth)Acrylate-Based Monomer

In the present embodiment, the “(meth)acrylate” means at least one of an acrylate and a methacrylate. The “(meth)acrylate-based monomer” includes, in addition to an acrylate compound represented by CH₂═CHCOOR (wherein R is an alkyl group) and a methacrylate compound, an ester compound having a known side chain or functional group in the structure of an acrylate derivative and a methacrylate derivative.

Examples of the (meth)acrylate-based monomer include monomers having a (meth)acrylic group, such as methyl (meth)acrylate, ethyl (meth)acrylate, n-butyl (meth)acrylate, isopropyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, phenyl (meth)acrylate, diethylaminoethyl (meth)acrylate, dimethylaminoethyl (meth)acrylate, and derivatives thereof. One of these may be contained alone, or two or more thereof may be contained in combination.

Among these, methyl methacrylate is preferably used. Since methyl methacrylate has a relatively short ester group end among (meth)acrylate-based monomers, it is possible to reduce the trapping of negative charges by the styrene-(meth)acrylic resin. That is, the residual charge amount of the toner can be reduced. In addition, since methyl methacrylate is resistant to physical impact as compared to other (meth)acrylate-based monomers having a relatively short ester group end, an image-formed product has excellent abrasion resistance.

The content of the constituent derived from the styrene-based monomer in the styrene-(meth)acrylic resin is preferably in a range of 40 to 90% by mass with respect to the total mass of the resin. The content of the constituent derived from the (meth)acrylate-based monomer in the resin is preferably in a range of 10 to 60% by mass with respect to the total mass of the resin.

### (c) Other Monomers

Examples of the monomer having a carboxy group among the other monomers include acrylic acid, methacrylic acid, maleic acid, itaconic acid, cinnamic acid, fumaric acid, maleic acid monoalkyl ester, and itaconic acid monoalkyl ester. Examples of the monomer having a hydroxy group among the other monomers include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate.

The content of the constituent derived from the other monomer in the styrene-(meth)acrylic resin is preferably in a range of 0.5 to 20% by mass with respect to the total mass of the resin.

The weight average molecular weight (Mw) of the styrene-(meth)acrylic resin is preferably 10,000 to 100,000.

A method for synthesizing the styrene-(meth)acrylic resin is not particularly limited. Examples of the polymerization initiator include peroxides, persulfides, persulfates, and azo compounds. Examples of the polymerization method include bulk polymerization, solution polymerization, an emulsion polymerization method, a mini-emulsion method, and a dispersion polymerization method. In addition, a common chain transfer agent can be used to adjust the molecular weight. The chain transfer agent is not particularly limited, and examples thereof include alkyl mercaptan (n-octyl mercaptan or the like) and mercapto fatty acid ester.

The glass transition temperature (Tg) of the styrene-(meth)acrylic resin is not particularly limited, but is preferably in a range of 25 to 60° C., from the viewpoint of obtaining fixability (low-temperature fixability or the like) and heat resistance (heat-resistant storage property, blocking resistance or the like).

### (1.1.1.2) Amorphous Polyester

The “amorphous polyester” refers to a polyester that exhibits amorphousness among polymers condensed from a polycarboxylic acid (divalent or higher-valent carboxylic acid) and a polyhydric alcohol (divalent or higher-valent alcohol). The amorphous polyester can be synthesized by polycondensation (esterification) of the aforementioned polycarboxylic acid monomer and polyhydric alcohol monomer using a known esterification catalyst.

The polycarboxylic acid is a compound containing two or more carboxy groups in one molecule.

Examples of the polycarboxylic acid include phthalic acid, isophthalic acid, terephthalic acid, trimellitic acid, naphthalene-2,6-dicarboxylic acid, malonic acid, mesaconic acid, dimethyl isophthalate, fumaric acid, dodecenyl succinic acid, and 1,10-dodecanedicarboxylic acid. Among these, dimethyl isophthalate, terephthalic acid, dodecenylsuccinic acid, and trimellitic acid are preferable.

One of these may be contained alone, or two or more of these may be contained in combination.

The polyhydric alcohol is a compound having two or more hydroxy groups in one molecule.

Examples of the polyhydric alcohol include dihydric or trihydric alcohols such as ethylene glycol, propylene glycol, 1,4-butanediol, 2,3-butanediol, diethylene glycol, triethylene glycol, 1,5-pentanediol, 1,6-hexanediol, neopentyl glycol, 1,4-cyclohexanedimethanol, dipropylene glycol, polyethylene glycol, polypropylene glycol, ethylene oxide adduct of bisphenol A (BPA-EO), propylene oxide adduct of bisphenol A (BPA-PO), glycerin, sorbitol, 1,4-sorbitan, and trimethylolpropane. Examples of the polyhydric alcohol also include ester compounds, hydroxycarboxylic acid derivatives, and the like of these.

One of these may be contained alone, or two or more of these may be contained in combination.

From the viewpoint that bisphenols can be esterified similarly to alcohols, in the present embodiment, bisphenols are included in the “polyhydric alcohol”.

Among them, it is preferable that the polyhydric alcohol is an aliphatic polyhydric alcohol. The aliphatic polyhydric alcohol is preferably an aliphatic polyhydric alcohol having 5 or more carbon atoms. It is thought that, when having 5 or more carbon atoms, the number of electrons that can be accepted by the amorphous polyester increases, and thus the electrostatic attractive force can be suppressed by moving the generated charges.

The amorphous polyester is preferably not modified with a compound other than the monomer forming the repeating structure. That is, it is preferable that the amorphous polyester is not modified with a component other than the polycarboxylic acid and the polyhydric alcohol that constitute the amorphous polyester. In particular, the amorphous polyester is preferably not modified with a styrene-(meth)acrylic resin. With this configuration, when the toner base particles are formed, aggregations between the styrene-(meth)acrylic resins and between the polyesters become easier respectively, and the styrene-(meth)acrylic resin can be positioned at the inner side of the toner base particles and the polyester can be positioned at the outer side thereof.

Examples of the esterification catalyst for the amorphous polyester include alkali metal compounds (sodium, lithium, and the like), alkaline earth metal compounds (magnesium, calcium, and the like), metal compounds (aluminum, zinc, manganese, antimony, titanium, tin, zirconium, germanium, and the like), phosphorous acid compounds, phosphoric acid compounds, and amine compounds.

The polymerization temperature of the amorphous polyester is not particularly limited and is, for example, preferably in a range of 150 to 250° C. The polymerization time is not particularly limited and is, for example, preferably in a range of 0.5 to 10 hours. During the polymerization, the pressure in the reaction system may be reduced as necessary.

The content of the amorphous polyester is preferably in a range of 5 to 50 parts by mass with respect to 100 parts by mass of the binder resin. In addition, the content of the amorphous polyester is preferably 10 parts by mass or more and more preferably 30 parts by mass or more with respect to 100 parts by mass of the toner base particles.

### (1.1.1.3) Glass Transition Temperature

From the viewpoint of achieving both sufficient low-temperature fixability and heat-resistant storage property, the glass transition temperature (Tg) of the amorphous resin is preferably in a range of 30 to 70° C. and more preferably in a range of 40 to 65° C.

For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). Specifically, 5 mg of a sample is sealed in a sample container having q6.8 and H2.5 mm (manufactured by HITACHI, Ltd.) for the AL autosampler and a cover for the AL autosampler (manufactured by HITACHI, Ltd.). This is placed in a sample holder of the “AS3/DX”, and the temperature is changed in the order of temperature increase, temperature decrease, and temperature increase. In the first and second temperature increases, the temperature is increased from 0° C. to 150° C. at a temperature increase rate of 10° C./min, and the temperature is held at 150° C. for 1 minute. In the temperature decrease, the temperature is decreased from 150° C. to 0° C. at a temperature decrease rate of 10° C./min, and the temperature is held at 0° C. for 1 minute. The baseline shift in the measurement curve obtained in the second heating is determined. The intersection of an extended line of the baseline before the shift and a tangent line indicating the maximum inclination of the shifted portion of the baseline is defined as the glass transition temperature (Tg). An empty aluminum pan is used for a reference.

### (1.1.1.4) Weight Average Molecular Weight

The weight average molecular weight (Mw) of the amorphous resin is not particularly limited and is, for example, preferably in a range of 10,000 to 100,000.

The weight average molecular weight of the amorphous resin can be measured in the same manner as the weight average molecular weight of the crystalline resin described below.

### (1.1.2) Crystalline Resin

When the crystalline resin is contained, the crystalline portion is melted when the temperature exceeds a melting point of the crystalline resin, and the crystalline resin and the amorphous resin are compatibilized with each other, thus improving low-temperature fixability.

In the present invention, the expression “exhibiting crystallinity” means that, in an endothermic curve obtained by DSC (differential scanning calorimetry), the curve does not show a stepwise endothermic change but has a clear endothermic peak at the time of temperature increase, that is, a melting point. The clear endothermic peak refers to a peak having a half value width of 15° C. or less in an endothermic curve when the temperature is increased at a temperature increase rate of 10° C./min.

It is preferable to use, as the crystalline resin, a known crystalline resin, for example, crystalline polyester or crystalline polyurethane resin. In particular, crystalline polyester is preferable from the viewpoints of sharp melting property during melting and compatibility with the binder resin.

### (1.1.2.1) Crystalline Polyester

The “crystalline polyester” refers to a polyester that exhibits crystallinity among polymers condensed from a polycarboxylic acid (divalent or higher-valent carboxylic acid) and a polyhydric alcohol (divalent or higher-valent alcohol).

Examples of the polycarboxylic acid include dicarboxylic acids such as aliphatic dicarboxylic acids, aromatic dicarboxylic acids, and the like. Among these, it is preferable that the polycarboxylic acid is an aliphatic dicarboxylic acid. From the viewpoint of increasing the crystallinity, the aliphatic dicarboxylic acid is preferably a linear aliphatic dicarboxylic acid.

Examples of the aliphatic dicarboxylic acid include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid (dodecanedioic acid), 1,13-tridecanedicarboxylic acid, 1,14-tetradecanedicarboxylic acid, 1,16-hexadecanedicarboxylic acid, 1,18-octadecanedicarboxylic acid, lower alkyl esters thereof, and acid anhydrides thereof. Among these, from the viewpoint of achieving both low-temperature fixability and transferability, aliphatic dicarboxylic acids having 6 to 16 carbons are preferable, and aliphatic dicarboxylic acids having 10 to 14 carbons are more preferable.

Examples of the aromatic dicarboxylic acid include terephthalic acid, isophthalic acid, orthophthalic acid, t-butylisophthalic acid, 2,6-naphthalenedicarboxylic acid, and 4,4′-biphenyldicarboxylic acid. Among these, terephthalic acid, isophthalic acid, or t-butylisophthalic acid is preferable from the viewpoints of availability and emulsifiability.

One of these may be contained alone, or two or more thereof may be contained in combination.

From the viewpoint of crystallinity, the content of the constituent derived from an aliphatic dicarboxylic acid with respect to the constituent derived from a dicarboxylic acid is preferably 50 mol % or more, and more preferably 70 mol % or more. The content is more preferably 80 mol % or more, and particularly preferably 100 mol %.

Examples of the polyhydric alcohol include diols, such as aliphatic diols. From the viewpoint of enhancing the crystallinity, the aliphatic diol is preferably a linear aliphatic diol.

Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among these, from the viewpoint of achieving both low-temperature fixability and transferability, aliphatic diols having 2 to 12 carbons are preferable, and aliphatic diols having 4 to 6 carbons are more preferable.

The polyhydric alcohol may include a diol other than the aliphatic diol. Examples of the other diol include diols having a double bond and diols having a sulfonic acid group. Specific examples of the diols having a double bond include 2-butene-1,4-diol, 3-butene-1,6-diol, and 4-butene-1,8-diol.

A method for synthesizing the crystalline polyester is not particularly limited. The polyester resin can be synthesized by polycondensation (esterification) of the above-described polyhydric alcohol component and polycarboxylic acid component using a known esterification catalyst.

The ratio between the polyhydric alcohol component and the polycarboxylic acid component is not particularly limited. For example, the equivalent ratio of hydroxy groups in the polyhydric alcohol component to carboxy groups in the polycarboxylic acid component is preferably in a range of 1.5/1 to 1/1.5, and more preferably in a range of 1.2/1 to 1/1.2.

Examples of the catalyst that can be used in the synthesis of the crystalline polyester include alkali metal compounds (sodium, lithium, and the like), alkaline earth metal compounds (magnesium, calcium, and the like), metal compounds (aluminum, zinc, manganese, antimony, titanium, tin, zirconium, germanium, and the like), phosphorous acid compounds, phosphoric acid compounds, and amine compounds.

Specifically, examples of the tin compound include dibutyltin oxide, tin octylate, tin dioctylate, and the salts thereof.

Examples of the titanium compound include titanium alkoxides (tetra-n-butyl titanate, tetraisopropyl titanate, tetramethyl titanate, tetrastearyl titanate, and the like), titanium acylates (polyhydroxy titanium stearate and the like), and titanium chelates (titanium tetraacetylacetonate, titanium lactate, titanium triethanolaminate, and the like).

Examples of the germanium compound include germanium dioxide.

Examples of the aluminum compound include oxides such as polyaluminum hydroxide, aluminum alkoxide, and tributyl aluminate.

One of these may be used alone, or two or more of these may be used in combination.

The polymerization temperature and the polymerization time are not particularly limited, and the pressure in the reaction system may be reduced as necessary during the polymerization.

The crystalline polyester is preferably not modified with a compound other than the monomer forming the repeating structure. That is, it is preferable that the crystalline polyester is not modified with a component other than the polycarboxylic acid and the polyhydric alcohol that constitute the crystalline polyester. In particular, the crystalline polyester is preferably not modified with a styrene-(meth)acrylic resin. With this configuration, when the toner base particles are formed, aggregations between the styrene-(meth)acrylic resins and between the polyesters become easier respectively, and the styrene-(meth)acrylic resin can be positioned at the inner side of the toner base particles and the polyester can be positioned at the outer side thereof.

### (1.1.2.2) Melting Point

From the viewpoint of low-temperature fixability and hot offset resistance, the melting point (Tm) of the crystalline resin is preferably in a range of 55 to 90° C., and more preferably in a range of 60 to 85° C. The melting point of the crystalline resin can be controlled by controlling its resin composition.

When the crystalline resin is a crystalline polyester, the melting point of the crystalline polyester is preferably 75° C. or lower.

The melting point (Tm) is a peak top temperature in the endothermic peak, and can be measured by DSC (differential scanning calorimetry).

For example, differential scanning calorimetry (DSC measurement) is performed using a differential scanning calorimeter “DSC7000X” (manufactured by Hitachi, Ltd.) and a thermal analyzer controller “AS3/DX” (manufactured by Hitachi, Ltd.). Specifically, 5 mg of a sample is sealed in a sample container having q6.8 and H2.5 mm (manufactured by HITACHI, Ltd.) for the AL autosampler and a cover for the AL autosampler (manufactured by HITACHI, Ltd.). This is placed in a sample holder of the “AS3/DX”, and the temperature is changed in the order of temperature increase, temperature decrease, and temperature increase. In the first and second temperature increases, the temperature is increased from 0° C. to 150° C. at a temperature increase rate of 10° C./min, and the temperature is held at 150° C. for 1 minute. In the temperature decrease, the temperature is decreased from 150° C. to 0° C. at a temperature decrease rate of 10° C./min, and the temperature is held at 0° C. for 1 minute. The temperature at the top of the endothermic peak in an endothermic curve obtained in the second heating is measured as the melting point.

### (1.1.2.3) Weight Average Molecular Weight

The weight average molecular weight of the crystalline resin is not particularly limited. From the viewpoint of tacking suppression and low-temperature fixability, the weight average molecular weight is preferably in a range of 1,000 to 29,000, more preferably in a range of 1,000 to 20,000, and further preferably in a range of 1,000 to 15,000.

The weight average molecular weight of the crystalline resin can be measured by the following method.

For example, an apparatus of gel permeation chromatography “HLC 8320GPC” (manufactured by Tosoh Corp.), in which one column “TSK gel guard column SuperHZ-L”, and three columns “TSK gel Super HZM-M” (all manufactured by Tosoh Corp.) are connected, is used.

The columns (TSK-) are stabilized at 40° C., and tetrahydrofuran (THF) as a carrier-solvent is allowed to flow through the columns at the same temperature at a flow rate of 0.35 mL/min. THE solution of the measurement sample (resin) adjusted to have a sample concentration of 1 mg/mL is treated with a roll mill at a room temperature for 10 minutes. The solution is treated with a membrane filter having a pore size of 0.2 μm to obtain a sample solution. The sample solution (10 μL) is injected into the apparatus together with the carrier solvent, and the measurement is performed using a refractive index detector (RI detector).

A calibration curve is drawn using polystyrene standard samples having a monodisperse molecular weight distribution. The molecular weight distribution of the measurement sample is calculated based on the calibration curve. The calibration curve was obtained using ten samples of “polystyrene standard sample TSK standard”: “A-500” and “F-1”, “F-10”, “F-80”, “F-380”, “A-2500”, “F-4”, “F-40”, “F-128”, and “F-700” manufactured by Tosoh Corp. The data collection interval in the sample analysis is 300 ms.

Alternatively, the crystalline resin and the release agent in the toner may be separated from each other as described below, and then the weight average molecular weight of the crystalline resin may be calculated by the above-described measurement method.

### (Separation of Crystalline Resin)

A case where the crystalline resin is crystalline polyester will be described as an example.

First, the toner is dispersed in ethanol, which is a poor solvent for the toner, and this dispersion liquid is heated to a temperature exceeding the melting points of the crystalline polyester and the release agent. In this step, pressure may be applied as necessary. At this point, the crystalline polyester and the release agent at a temperature exceeding the melting point are dissolved in ethanol. Thereafter, a mixture of the crystalline polyester and the release agent can be collected from the toner by performing solid-liquid separation. The crystalline polyester and the release agent can be separated from the toner by subjecting the mixture to molecular weight fractionation.

### (Acid Value of Crystalline Resin)

In light of low-temperature fixability and fold fixability, the acid value of the crystalline polymer is preferably in a range of 9 to 30 mgKOH/g, and more preferably in a range of 15 to 23 mgKOH/g.

The acid value of the crystalline polyester is expressed in mg (mgKOH/g) of potassium hydroxide required for neutralizing carboxy groups present in 1 g of the resin. Specifically, it is determined by the following method in accordance with JIS K0070-1992.

### (1) Preparation of Reagents

### (a) Phenolphthalein Solution

1.0 g of phenolphthalein is dissolved in 90 mL of ethanol (95% by volume), and ion exchange water is added to obtain 100 mL of a phenolphthalein solution.

### (b) Potassium Hydroxide Solution

7 g of special-grade potassium hydroxide is dissolved in 5 mL of ion exchange water, and ethanol (95% by volume) is added thereto to obtain 1 L of the solution. The solution is placed in an alkali-resistant container so as not to be in contact with carbon dioxide gas or the like, left to stand for 3 days, and then filtered to obtain a potassium hydroxide solution. The obtained potassium hydroxide solution is stored in an alkali-resistant container.

### (c) Factor of Potassium Hydroxide Solution

25 mL of 0.1 mol/L hydrochloride solution is placed in a conical flask, and several drops of the phenolphthalein solution are added. The solution is then titrated with the potassium hydroxide solution. The factor of the potassium hydroxide solution is determined from the amount of the potassium hydroxide solution required for the neutralization.

### (d) Hydrochloric Acid Solution

The 0.1 mol/L hydrochloride solution to be used is prepared in accordance with JIS K8001-1998.

### (2) Operation

### (a) Main Test

2.0 g of toner is precisely weighed into a 200 mL Erlenmeyer flask, 100 mL of a mixed solution of toluene:ethanol (2:1), is added to the Erlenmeyer flask, and the toner is allowed to be dissolved over the course of 5 hours. Next, several drops of the phenolphthalein solution are added as an indicator to the Erlenmeyer flask, and titration is performed using the potassium hydroxide solution. Note that the end point of the titration is when the pale red color of the indicator continues for about 30 seconds.

### (b) Blank Test

The same titration as in the above-described main test is performed except that the sample is not used, that is, only the mixed solution of toluene:ethanol (2:1) is used.

(3) The Acid Value is Calculated by Substituting the Obtained Results into the Following Equation.

A=[(C−D)×f×5.611]/S

In the equation, the symbols and numerals represents as follows.
A: acid value (mgKOH/g)
C: amount (mL) of potassium hydroxide solution added in the main test
D: amount (mL) of the potassium hydroxide solution added in the blank test
f: factor of 0.1 mol/L potassium hydroxide-ethanol solution
5.611: molar mass of potassium hydroxide 56.11 (g/mol)×( 1/10)
S: mass of sample (g)

### (1.1.3) Ratio of Styrene-(Meth)Acrylic Resin and Polyester

In the binder resin, the mass ratio of the styrene-(meth)acrylic resin to the polyester is preferably in a range of 80:20 to 1:99, and more preferably in a range of 60:40 to 5:95. When the ratio of the polyester is relatively high, the charge tends to escape to the outside of the toner, and the blocking phenomenon tends to be reduced.

### (1.2) Release Agent

The release agent is not particularly limited, and examples thereof include various known release agents. Examples thereof include polyolefin waxes (polyethylene waxes, polypropylene waxes, and the like), branched hydrocarbon waxes (microcrystalline waxes, and the like), long-chain hydrocarbon-based waxes (paraffin waxes, Sasol wax, and the like), synthetic waxes (Fischer-Tropsch wax, and the like), dialkyl ketone-based waxes (distearyl ketone, and the like), ester-based waxes (carnauba wax, montan wax, behenyl behenate, trimethylolpropane tribehenate, pentaerythritol tetrabehenate, pentaerythritol diacetate dibehenate, glycerol tribehenate, 1,18-octadecanediol distearate, tristearyl trimellitate, distearyl maleate, and the like), and amide-based wax (ethylenediamine behenylamide, trimellitic acid tristearylamide, and the like).

One of these may be contained alone, or two or more of these may be contained in combination. Among these, it is preferable that the release agent is a wax having high polarity, that is, an ester-based wax or an amide-based wax. A wax having high polarity tends to be dispersed in the styrene-(meth)acrylic resin or the polyester.

The melting point of the release agent is preferably in a range of 60 to 80° C. When the melting point is 60° C. or higher, the release agent can be prevented from volatilizing and forming fine particles at the time of fixing of the toner, and the environmental load can be reduced. When the melting point is 80° C. or lower, the release agent is melted at the time of fixing of the toner, and separation performance from a fixing member is satisfactory.

The content of the release agent is preferably 7% by mass or less, and more preferably in a range of 3 to 7% by mass with respect to the total mass of the toner base particles. When the content of the release agent is within the above range, sufficient fixing separability can be obtained.

### (1.3) Coloring Agent

The coloring agent is not particularly limited, and examples thereof include various known dyes and pigments.

Examples of the coloring agent contained in a yellow toner include C.I. Solvent Yellows 19, 44, 77, 79, 81, 82, 93, 98, 103, 104, 112, and 162. Examples of the coloring agent include C. I. Pigment Yellows 14, 17, 74, 93, 94, 138, 155, 180, and 185. One of these may be contained alone, or two or more of these may be contained in combination.

Examples of the coloring agent contained in a magenta toner include C.I. Solvent Reds 1, 49, 52, 58, 63, 111, and 122. Examples of the coloring agent include C. I. Pigment Reds 5, 48:1, 53:1, 57:1, 122, 139, 144, 149, 166, 177, 178, and 222. One of these may be contained alone, or two or more of these may be contained in combination.

Examples of the coloring agent contained in a cyan toner include C. I. Pigment Blue 15:3.

Examples of the coloring agent contained in a black toner include carbon black, a magnetic material, and titanium black. Examples of the carbon black include channel black, furnace black, acetylene black, thermal black, and lamp black. Examples of the magnetic substance include ferromagnetic metal (iron, nickel, cobalt, and the like), alloy containing ferromagnetic metal, compounds of ferromagnetic metals (ferrite, magnetite, and the like), and alloys containing no ferromagnetic metal but exhibiting ferromagnetism by heat treatment. Examples of the alloy that exhibits ferromagnetism by heat treatment include Heusler alloys (manganese-copper-aluminum, manganese-copper-tin, and the like) and chromium dioxide.

The content of the coloring agent is preferably 1 to 10% by mass, more preferably 4 to 9% by mass with respect to the total mass of the toner base particles.

### (1.4) Charge Control Agent

Examples of the charge control agent include various known compounds.

The content of the charge control agent is preferably in a range of 0.1 to 5.0 parts by mass with respect to the total mass of the toner base particles.

### (2) External Additive

In the toner according to the present embodiment, an external additive may be further added to the toner base particles. Addition of an external additive can further improve the fluidity, chargeability, cleanability, and the like of the toner.

Metal oxide particles can be used as the external additive from the viewpoint that fluidity and chargeability can be controlled. Examples of the metal oxide particles include silica particles, titania particles, alumina particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles.

One of these may be used alone, or two or more of these may be used in combination.

Organic particles can be used as the external additive. Examples of the organic particles include homopolymers or copolymers of styrene, methyl methacrylate, and the like.

A lubricant can be used as the external additive from the viewpoint of improving cleaning performance and transferability. Examples of the lubricant include metal salts of higher fatty acids, such as stearic acid salts (zinc, aluminum, copper, magnesium, calcium, and the like), oleic acid salts (zinc, manganese, iron, copper, magnesium, and the like), palmitic acid salts (zinc, copper, magnesium, calcium and the like), linoleic acid salts (zinc, calcium, and the like), and ricinoleic acid salts (zinc, calcium, and the like).

From the viewpoint of heat-resistant storage property and environmental stability, a hydrophobic treatment may be performed with a silane coupling agent, a titanium coupling agent, a higher fatty acid, silicone oil, or the like.

The shape of the external additive is not limited. Examples of the shape of the external additive include a spherical shape, a flat shape, a plate shape, and a needle shape.

The total amount of the external additives to be added is preferably in a range of 2 to 10 parts by mass, and more preferably in a range of 4 to 7 parts by mass, with respect to the 100 parts by mass of the toner.

### 2. Structure of Electrostatic Charge Image Developing Toner (Core-Shell Structure)

The toner base particles may have a multilayer structure. Examples of the multilayer structure include a core-shell structure including a core particle and a shell layer covering the surface of the core particle.

The shell layer may not cover the entire surface of the core particle, and the core particle may be partially exposed. The cross section of the core-shell structure can be confirmed by a known observation means such as a transmission electron microscope (TEM) or a scanning probe microscope (SPM).

When the toner base particles have a core-shell structure, the core particle and the shell layer may have different properties in glass transition temperature, melting point, hardness, and the like, depending on the purpose. For example, core particles containing a binder resin, a coloring agent, a release agent, and the like and having a relatively low glass transition temperature (Tg) are prepared. Then, a resin having a relatively high glass transition temperature (Tg) is aggregated and fused with the core particles to form shell layers. The shell layers preferably contain an amorphous resin. Such a configuration allows for both low-temperature fixability and heat-resistant storage property. In addition, satisfactory charge retention performance is obtained.

In the present embodiment, from the viewpoint that it is preferable that the polyester is positioned at the outer side of the toner base particles, the shell layer preferably contains an amorphous polyester.

### 3. Physical Properties and Shape of Electrostatic Charge Image Developing Toner

### (1) Loss Tangent (Tan δ) of Toner

A loss tangent (tan δ) T(70) of the toner at 70° C. in viscoelasticity measurement is preferably in a range of 0.2 to 1.2.

When the loss tangent T(70) is 0.2 or more, the fixability of the toner is excellent. When the loss tangent T(70) is 1.2 or less, the image layer does not tend to adhere to the back surface of the recording medium even when the image-formed product is wound up and stored before the temperature decreases completely after fixing, and thus the reduction in blocking and the abrasion resistance are excellent.

The loss tangent T(70) of the toner can be measured using, for example, a rheometer “ARES G2” (manufactured by TA Instruments Co., Ltd.).

Specifically, a toner is weighed to 0.2 g as a measurement sample. Each weighed toner is pressure-molded by a compression molder under 25 MPa pressures to produce a cylindrical pellet of each toner having a diameter of mm.

The temperature of the toner sample is increased from 30° C. to 150° C. at a rate of 3° C./min, and the storage elastic modulus (G′) and the loss elastic modulus (G″) are measured with the increase in temperature. The value of the loss tangent (tan δ) can be calculated from the relationship of (loss elastic modulus/storage elastic modulus) at 70° C.

The loss tangent T(70) of the toner can be adjusted by the types and contents of the components constituting the toner base particles. In particular, it can be adjusted by the structures of monomers constituting each of the styrene-(meth)acrylic resin and the polyester. Furthermore, it can be adjusted by the mass ratio of the styrene-(meth)acrylic resin to the polyester. It can also be adjusted by the type of the release agent, the dispersibility of the release agent in the toner base particles, and the like.

### (2) Glass Transition Temperature of Toner

From the viewpoint of achieving both sufficient low-temperature fixability and heat-resistant storage property, the glass transition temperature (Tg) of the toner is preferably in a range of 15 to 40° C. and more preferably in a range of 20 to 35° C. The glass transition temperature can be measured by the above-described method.

### (3) Volume Average Particle Size of Toner Base Particles

The volume average particle size of the toner base particles is, for example, preferably in a range of 3 to 10 μm, and more preferably in a range of 4 to 8 μm, in terms of a volume-based median diameter (d50). The volume average particle size of the toner base particles can be controlled by controlling the concentration of a coagulant used in the production of the toner base particles, the amount of an organic solvent added, a fusion time, the composition of the binder resin, and the like. When the volume-based median diameter (d50) is within the above range, a very fine dot image at the 1,200 dpi level can be faithfully reproduced.

The volume-based median diameter (d50) of the toner base particles can be measured and calculated by using, for example, a measuring device in which “Multisizer 3” (manufactured by Beckman Coulter, Inc.) is connected to a computer system equipped with the software for data processing “Software V3.51”.

The measurement procedure is as follows. 0.02 g of a toner sample is wet with 20 mL of a surfactant solution and then subjected to an ultrasonic dispersion for 1 minute to prepare a dispersion liquid of toner base particles. Note that the surfactant solution is obtained, for example, by diluting a neutral detergent containing a surfactant component with pure water by a factor of 10 for the purpose of dispersing the toner base particles.

The toner base particle dispersion liquid is injected into a beaker containing “ISOTON II” (manufactured by Beckman Coulter, Inc.) placed in a sample stand with a pipette until the measurement concentration reaches 5 to 10%. With this concentration, a measurement value can be obtained with high reproducibility.

In the measuring device, the number of counted measurement particles is set to 25,000, and the aperture diameter is set to 100 μm. The range of 1 to 30 μm, which is the measurement range of the particle size of the toner base particles, is divided into 256 segments, and the frequency value of the particle size of the toner base particles is calculated. The particle size of 50% particles from the largest volume integrated fraction is defined as a volume-based median diameter (d50).

### (4) Average Circularity of Toner Base Particles

From the viewpoint of stability of charging characteristics, fluidity, and low-temperature fixability, the average circularity of the toner base particles is preferably 0.945 or more.

The average circularity of the toner base particles can be measured using, for example, a flow particle image analyzer “FPIA-3000” (manufactured by Sysmex Corporation).

Specifically, a toner sample to be measured is added to a surfactant solution and mixed, diluted with pure water, and then subjected to ultrasonic dispersion to prepare a toner base particle dispersion liquid. In the surfactant solution, for example, an anionic surfactant such as sodium polyoxyethylene lauryl ether sulfate is suitably used for the purpose of dispersing the toner base particles. Then, for example, using a flow-type particle image analyzer “FPIA-3000” (manufactured by Sysmex Corporation), an image is captured at an appropriate density, i.e., an HPF detection number of 3,000 to 10,000, in a measurement condition of the HPF (high magnification imaging) mode.

The circularity of each toner base particle is calculated according to the following equation. The average circularity is defined as an arithmetic average value obtained by adding up the circularities of the respective toner base particles and dividing the sum by the total number of the toner base particles. When the number of HPF detections is within the above range, high reproducibility is obtained.

Circularity=(Perimeter of circle having the same projected area as particle image)/(Perimeter of particle projection image) Equation:

### 4. Method for Producing Electrostatic Charge Image Developing Toner

The method for producing the toner base particles is not particularly limited. Examples of the production method include a kneading and pulverizing method, a suspension polymerization method, an emulsion aggregation method, a dissolution suspension method, a polyester elongation method, a dispersion polymerization method, and other known methods. Among these, the emulsion aggregation method is preferable from the viewpoint that the configuration of the inside of the particles and the shape of the particles can be controlled. That is, the toner base particles according to the present embodiment are preferably an emulsion aggregate.

In the emulsion aggregation method, first, an aqueous dispersion liquid of amorphous polyester fine particles and, if necessary, an aqueous dispersion liquid of fine particles of a release agent, a coloring agent, an amorphous resin other than the amorphous polyester, a crystalline resin, and the like are mixed together. Then, these fine particles are aggregated to form wet toner base particles.

The term “aqueous dispersion liquid” as used herein refers to a material in which dispersions (particles) are dispersed in an aqueous medium. The main component, that is, a component accounting for 50% by mass or more of the aqueous medium is water.

Examples of the components other than water contained in the aqueous medium include organic solvents that dissolve in water. Examples of the water-soluble organic solvents include methanol, ethanol, isopropanol, butanol, acetone, methyl ethyl ketone, and tetrahydrofuran. Among these, from the viewpoint of not dissolving the resin, an alcohol-based organic solvent such as methanol, ethanol, isopropanol, and butanol are preferable.

Hereinafter, an example of the method for producing a toner will be described, but the method is not limited thereto. Both of steps (b) and (c) are not necessarily performed, and only one of the steps (b) and (c) may be performed. When another resin is used as the binder resin, a step of preparing a resin particle dispersion liquid may be added.
(a) Synthesizing a styrene-(meth)acrylic resin and preparing a styrene-(meth)acrylic resin particle dispersion liquid
(b) Synthesizing a crystalline polyester and preparing a crystalline polyester particle dispersion liquid
(c) Synthesizing an amorphous polyester to prepare an amorphous polyester particle dispersion liquid
(d) Preparing a release agent particle dispersion liquid
(e) Preparing a coloring agent particle dispersion liquid
(f) Aggregating the styrene-(meth)acrylic resin particles, the crystalline polyester particles, the amorphous polyester particles, the release agent particles, and the coloring agent particles to form core particles of toner base particles
(g) Aggregating the amorphous polyester particles on surfaces of the core particles of the toner base particles to form shell layers of the toner base particles
(h) Fusing and aging the toner base particles by thermal energy to control a shape thereof
(i) Cooling the dispersion liquid of the toner base particles
(j) Separating the toner base particles from aqueous medium by filtration, and washing the toner base particles to remove surfactants and the like, thereby obtaining wet toner base particles
(k) Drying the wet toner base particles
(l) Adding external additives to the dried toner base particles

### (a) Synthesizing a Styrene-(Meth)Acrylic Resin and Preparing a Styrene-(Meth)Acrylic Resin Particle Dispersion Liquid

In this step, a styrene-(meth)acrylic resin is synthesized and dispersed in the form of particles in an aqueous medium to prepare a styrene-(meth)acrylic resin particle dispersion liquid.

The synthesized styrene-(meth)acrylic resin is dissolved or dispersed in an organic solvent to prepare an oil phase liquid. Next, the oil phase liquid is dispersed in an aqueous medium by phase inversion emulsification or the like to form oil droplets controlled to have a desired particle size. Thereafter, the organic solvent is removed to prepare an aqueous dispersion liquid of styrene-(meth)acrylic resin particles.

The styrene-(meth)acrylic resin particles may have a multilayer structure including two or more layers having different compositions. In this case, a polymerization initiator and a monomer are added to a dispersion liquid prepared by an emulsion polymerization treatment (first stage polymerization), and this mixture is further subjected to polymerization treatments (second stage polymerization and third stage polymerization).

The amount of the aqueous medium used is preferably in a range of 50 to 2,000 parts by mass, and more preferably in a range of 100 to 1,000 parts by mass with respect to 100 parts by mass of the oil phase liquid. A surfactant or the like may be added to the aqueous medium from the viewpoint of dispersion stability of oil droplets. Examples of the surfactant include various conventionally known anionic surfactants, cationic surfactants, and nonionic surfactants.

From the viewpoint of removal treatment after formation of oil droplets, the organic solvent used in the preparation of the oil phase liquid preferably has a low boiling point and low solubility in water. Specific examples thereof include methyl acetate, ethyl acetate, methyl ethyl ketone, methyl isobutyl ketone, toluene, and xylene.

One of these may be used alone, or two or more of these may be used in combination.

The amount of the organic solvent used is preferably in a range of 1 to 300 parts by mass with respect to 100 parts by mass of the styrene-(meth)acrylic resin. The emulsification and dispersion of the oil phase liquid can be achieved using mechanical energy.

If necessary, an internal additive such as a release agent or a charge control agent may be dissolved or dispersed in advance, for example, in the monomer solution. Thus, the internal additive can be introduced into the resin particles, and finally into the toner base particles.

Specifically, in the synthesis of the styrene-(meth)acrylic resin, it is preferable to add a part of the release agent to the monomer solution during the second stage polymerization. In the toner base particles according to the present embodiment, the styrene-(meth)acrylic resin is positioned at the inner side, and by introducing a release agent into the styrene-(meth)acrylic resin particles, the release agent can also be dispersed to some extent at the inner side of the toner base particles. In addition, by adding the release agent during the second stage polymerization, the release agent can be confined inside the styrene-(meth)acrylic resin particles as compared with the case of adding the release agent during the third stage polymerization. By adding the release agent during the second stage polymerization, the release agent is more likely to exude to the outside of the styrene-(meth)acrylic resin particles when the particles constituting the toner base particles are fused and aged as compared with the case where the release agent is added during the first stage polymerization.

The average particle size of the styrene-(meth)acrylic resin particles is preferably in a range of 100 to 400 nm in terms of volume-based median diameter (d50). The volume-based median diameter (d50) can be measured using, for example, “Microtrac UPA-150” (manufactured by Nikkiso Co., Ltd).

### (b) Synthesizing a Crystalline Polyester and Preparing a Crystalline Polyester Particle Dispersion Liquid

In this step, a crystalline polyester is synthesized and dispersed in the form of particles in an aqueous medium to prepare a crystalline polyester particle dispersion liquid. The crystalline polyester particle dispersion liquid can be prepared by the same procedure as the (a) styrene-(meth)acrylic resin particle dispersion liquid. If necessary, the temperature at the time of dispersion is preferably adjusted.

### (c) Synthesizing an Amorphous Polyester to Prepare an Amorphous Polyester Particle Dispersion Liquid

In this step, an amorphous polyester is synthesized and dispersed in the form of particles in an aqueous medium to prepare an amorphous polyester particle dispersion liquid. The amorphous polyester particle dispersion liquid can be prepared by the same procedure as the (a) styrene-(meth)acrylic resin particle dispersion liquid. If necessary, the temperature at the time of dispersion is preferably adjusted.

### (d) Preparing a Release Agent Particle Dispersion Liquid

This step is performed as necessary when a release agent is contained in the toner base particles.

The dispersion liquid of the release agent particles can be prepared by dispersing a release agent in an aqueous medium to which a surfactant has been added in an amount equal to or more than the critical micelle concentration (CMC).

The release agent particle dispersion liquid may contain resin particles from the viewpoint of improving the dispersibility of the release agent particles. The resin particles are not particularly limited, but are preferably particles of a resin used for the binder resin.

The release agent can be dispersed by utilizing mechanical energy. The disperser is not particularly limited, and examples thereof include ultrasonic dispersers, mechanical homogenizers, pressure dispersers (Manton-Gaulin, a pressure-type homogenizer, and the like), and medium-type dispersers (a sand grinder, a diamond fine mill, and the like).

The volume-based median diameter (d50) of the release agent particles in a dispersed state is preferably in a range of 10 to 300 nm, more preferably in a range of 100 to 200 nm, and particularly preferably in a range of 100 to 150 nm. The volume-based median diameter (d50) of the release agent particles can be measured, for example, with an electrophoretic light scattering photometer “ELS-800” (manufactured by Otsuka Electronics Co., Ltd.).

### (e) Preparing a Coloring Agent Particle Dispersion Liquid

The dispersion liquid of the coloring agent particles can be prepared by the same procedure as the dispersion liquid of the release agent particles. The release agent particles are preferably heated to a melting point or higher for dispersion, but the coloring agent fine particles are not necessarily heated.

### (f) Aggregating the Styrene-(Meth)Acrylic Resin Particles, the Crystalline Polyester Particles, the Amorphous Polyester Particles, the Release Agent Particles, and the Coloring Agent Particles to Form Core Particles of Toner Base Particles

In this step, a coagulant is added to the dispersion liquid in which the above-described particles are dispersed, in an amount equal to or more than the critical coagulation concentration. The temperature of the reaction liquid is adjusted to aggregate the fine particles, thereby forming toner base particles. This step further includes the following steps (f1) to (f3). FIG. 6 is a flowchart of steps (f1) to (f3) in a method for producing a toner.
(f1) Heating a dispersion liquid of the styrene-(meth)acrylic resin particles to temperature T [° C.] to grow particle size
(f2) Mixing the dispersion liquid of the styrene-(meth)acrylic resin particles having temperature of T [C] with a dispersion liquid of the polyester particles while stirring
(f3) Holding the mixed liquid at temperature T [° C.] for a certain period of time while stirring

The temperature T [° C.] in (f1) to (f3) is a temperature higher than the glass transition temperature (Tg) of the styrene-(meth)acrylic resin by a range of 30 to 40° C. Performing steps (f1) to (f3) under conditions of the temperature T [° C.] facilitates growth of the particle size of the styrene-(meth)acrylic resin. Furthermore, in the formed toner base particles, the styrene-(meth)acrylic resin can be positioned at the inner side and the polyester can be positioned at the outer side.

The release agent particles and the coloring agent particles are added to the dispersion liquid of the styrene-(meth)acrylic resin particles, for example, between step (f1) and step (f2).

The polyester in (f2) may be a crystalline polyester, an amorphous polyester, or both of them.

In steps of (f1) to (f3), the number of rotations during stirring is not particularly limited, but is preferably in a range of 80 to 330 rpm. As a result, the styrene-(meth)acrylic resin can be positioned at the inner side and the polyester can be positioned at the outer side in the formed toner base particles.

In step (f3), the holding time is not particularly limited, but is preferably in a range of 20 to 120 minutes. As a result, the styrene-(meth)acrylic resin can be positioned at the inner side and the polyester can be positioned at the outer side in the formed toner base particles.

The coagulant is not particularly limited, but is preferably, for example, a metal salt such as an alkali metal salt or an alkaline earth metal salt. Examples of the metal salt include salts of monovalent metals such as sodium, potassium (sodium, potassium, lithium, and the like), salts of divalent metals (calcium, magnesium, manganese, copper, and the like), and salts of trivalent metals (iron, aluminum, and the like).

Specific examples of the metal salt include sodium chloride, potassium chloride, lithium chloride, calcium chloride, magnesium chloride, zinc chloride, copper sulfate, magnesium sulfate, manganese sulfate, aluminum chloride, aluminum sulfate, polyaluminum chloride, and polyaluminum hydroxide. Among them, the metal salt is preferably a trivalent metal salt from the viewpoint of the ability to causing aggregation with a smaller amount.

One of these may be used alone, or two or more of these may be used in combination.

In the toner base particles according to the present embodiment, the polyester is positioned at the outer side, and the release agent particles prepared in step (d) enter between the crystalline polyester and the amorphous polyester. Therefore, the release agent can also be dispersed to some extent at the outer side of the toner base particles. That is, the release agent can be uniformly dispersed in toner base particles by introducing the release agent into the styrene-(meth)acrylic resin particles and aggregating the release agent particles and the respective particles to form the toner base particles.

### (g) Aggregating the Amorphous Polyester Particles on Surfaces of the Core Particles of the Toner Base Particles to Form Shell Layers of the Toner Base Particles

In this step, the amorphous polyester particle dispersion liquid is added to the dispersion liquid in which the core particles of the toner base particles are dispersed. By adjusting pH, temperature, and the like of the reaction liquid, the amorphous polyester particles are aggregated on the surfaces of the core particles to form shell layers of the toner base particles.

### (h) Fusing and Aging the Toner Base Particles by Thermal Energy to Control a Shape Thereof

This step is performed as necessary when the aggregated particles in the toner base particles are fused and aged by thermal energy to control the shape of the toner base particles.

Specifically, in the aging treatment, the dispersion liquid of the toner base particles is heated and stirred while adjusting the heating temperature, the stirring speed, the heating time, and the like, so that the circularity of the toner base particles becomes a desired value.

### (i) Cooling the Dispersion Liquid of the Toner Base Particles

In this step, the dispersion liquid of the toner base particles is cooled. The cooling rate is preferably in a range of 1 to 20° C./min. The specific method of the cooling treatment is not particularly limited. Examples of the method include a method of cooling by introducing a refrigerant from the outside of the reaction vessel, a method of cooling by directly charging cold water into the reaction system, and a method of cooling with a heat exchanger.

(j) Separating the Toner Base Particles from Aqueous Medium by Filtration, and Washing the Toner Base Particles to Remove Surfactants and the Like, Thereby Obtaining Wet Toner Base Particles

In this step, the toner base particles are subjected to solid-liquid separation from the cooled dispersion liquid of the toner base particles. Next, the obtained toner cake is washed to remove adhered substances such as the surfactant and the coagulant, thereby obtaining wet toner base particles. The “toner cake” as used herein refers to an aggregate of wet toner base particles aggregated in a cake form.

The method of solid-liquid separation is not particularly limited, and examples thereof include a centrifugation method, a vacuum filtration method performed with a Nutsche filter or the like, and a filtration method performed with a filter press or the like. In the washing, the filtrate is preferably washed with water until the electrical conductivity of the filtrate becomes 10 μS/cm or less.

### (k) Drying the Wet Toner Base Particles

In this step, the wet toner base particles subjected to a washing treatment, and further subjected to a desolvation treatment in some cases, are dried.

### (l) Adding External Additives to the Dried Toner Base Particles

This step is performed as necessary when an external additive is added to the toner base particles.

The toner base particles can be directly used as a toner as they are. From the viewpoint of fluidity, chargeability, cleanability, and the like, external additives such as so-called fluidizing agents and cleaning aids may be further added to the toner base particles. Examples of a mixing device for an external additive include mechanical mixing devices such as a Henschel mixer and a coffee mill.

### 5. Developer

The toner can be used as a magnetic or non-magnetic mono-component developer. The toner may also be mixed with a carrier to form a two-component developer.

When the toner is used as a two-component developer, magnetic particles formed of a conventionally known material can be used as the carrier. Examples of the material of the magnetic particles include metals (iron, ferrite, magnetite, and the like), and alloys of metals with aluminum or other metals (lead, and the like). Among them, the magnetic particles are preferably ferrite particles.

The carrier may be a coated carrier in which the surface of magnetic particles is coated with a coating agent such as a resin, a dispersion type carrier in which a magnetic fine powder is dispersed in a binder resin, or the like.

The volume-based median diameter (d50) of the carrier is preferably in a range of 20 to 100 μm, and more preferably in a range of 25 to 80 μm. The volume-based median diameter (d50) of the carrier can be measured, for example, with a laser diffraction particle size distribution analyzer “HELOS” (manufactured by SYMPATEC GmbH) equipped with a wet disperser.

A mixing device to be used for mixing the toner and the carrier is not particularly limited, and examples thereof include a Nauta mixer, a W-cone type mixer, and a V-type mixer.

The content of the toner in the developer is preferably in a range of 4.0 to 8.0 parts by mass with respect to 100 parts by mass of the developer.

### 6. Recording Medium

The recording medium according to the present embodiment is long and has an air permeance of 20,000 sec or more at 25° C. The toner of the present embodiment is used for forming an image on the recording medium. Note that the term “long” herein specifically means 2 m or more.

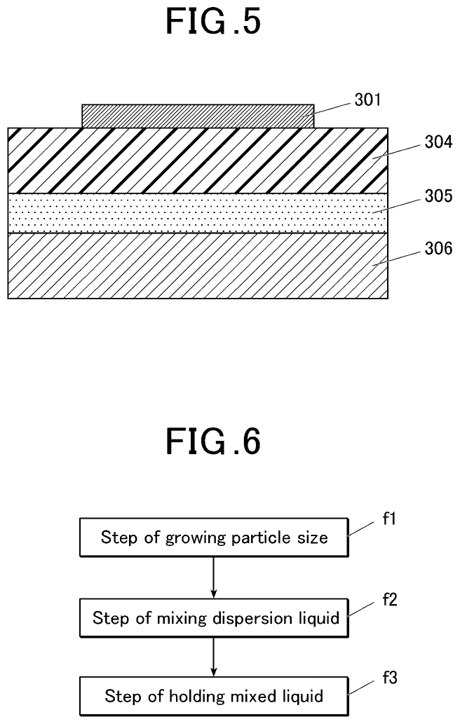

The material of the recording medium is not particularly limited. Examples of the recording medium include a resin film, a metal film, and paper coated with a resin. The resin film may be in the form of a film label having an adhesive and the like. FIG. 5 is a cross-sectional view of the film label 307 after image formation. The film label 307 includes an adhesive 305 on a surface of a resin film 304 opposite to the surface having an image layer 301. The film label 307 includes a release substrate 306 on the surface opposite to the surface on which the adhesive 305 is in contact with the resin film 304. Examples of the release substrate include release paper and a release film.

In the present embodiment, the “resin film” refers to a film containing a resin as a main component, and specifically, a film containing a resin in an amount of 60% by mass or more.

Examples of the resin of the resin film include polypropylene, polyethylene, polyvinyl chloride, polyethylene terephthalate, polystyrene, polyester, and polylactic acid. One of these may be contained alone, or two or more of these may be contained in combination. Among these, from the viewpoint of versatility and the like, the resin is preferably polyethylene, polypropylene, or polyethylene terephthalate.

The resin film can be used for various labels, packages, and the like. The resin film may be appropriately subjected to a surface treatment for the purpose of improving printability. Examples of the surface treatment method include a corona treatment and a plasma treatment. The resin film may be a transparent film. The resin film may contain a pigment or the like and have any color such as white. A toner-receiving layer may be formed on the surface of the resin film.

The air permeance of the recording medium at 25° C. can be measured in conformity with JIS P8117:2009 using, for example, an Oken type air permeance tester (manufactured by KUMAGAI RIKI KOGYO Co., Ltd.) by the following procedure. The tester is started and the measurement reference air pressure is adjusted to 49.03 hPa (500 mmH₂O). Each of the recording media to be measured is cut into a A4 size to prepare three samples, and one of the samples is set in a measurement portion of the tester. Note that the sample is set such that the side (surface) on which an image is formed is facing upward. Thereafter, the switch of the tester is turned to the start side to start a measurement, and the number of seconds measured by the tester is recorded. The measurement is performed on each of three samples, and the arithmetic mean value of them is defined as the air permeance [sec].

The air permeance at the temperature of 25° C. and the pressure of 49.03 hPa (500 mmH₂O) is preferably 25,000 sec or more. With this configuration, the blocking phenomenon can be further reduced.

In the present embodiment, the air permeance of the recording medium is measured in the form at the time of image formation. For example, in the case of the film label 307 shown in FIG. 5, since the release substrate 306 is still attached at the time of image formation, the release substrate 306 is still attached also in the measurement of the air permeance. That is, the air permeance at 25° C. of the film label 307 as a whole including the resin film 304, the adhesive 305, and the release substrate 306 is 20,000 sec or more.

The thickness of the recording medium is preferably in a range of 20 to 1,000 μm and more preferably in a range of 40 to 500 μm. Note that in a case where the recording medium includes a release substrate, it is preferable that the thickness including the thickness of the release substrate satisfies the above-described range.

### 7. Image Forming Method

The image forming method of the present embodiment forms an image on the recording medium using the toner in the form of the developer.

The image forming method of the present embodiment is an image forming method of forming an image on a recording medium using a toner for developing electrostatic charge image which includes toner base particles containing a binder resin, wherein
the binder resin contains a styrene-(meth)acrylic resin and a polyester,
the mass ratio of the styrene-(meth)acrylic resin to the polyester is in a range of 80:20 to 1:99,
the recording medium is long, and
the recording medium has an air permeance of 20,000 sec or more.

Hereinafter, an example of the image forming method using the two-component developer is described below, but the image forming method of the present embodiment is not limited thereto as long as the developer and the recording medium described above are used.

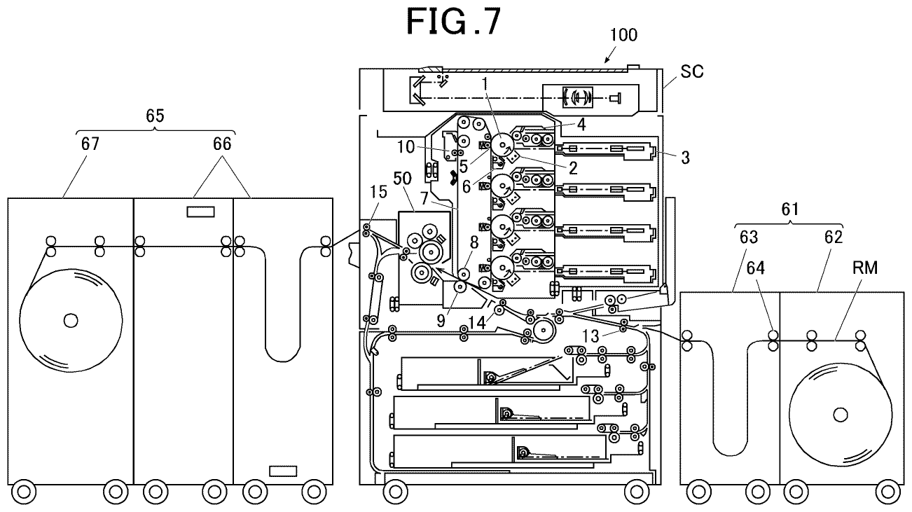

The image forming method of the present embodiment can be carried out using an image forming apparatus of an electrophotographic method. FIG. 7 is a schematic cross-sectional view of an image forming apparatus of an electrophotographic method.

The image forming method of the electrophotographic method preferably includes the following steps.
1) Charging step of charging a surface of an image holding member (photoreceptor)
2) Electrostatic charge image forming step of forming an electrostatic charge image on the surface of the charged image holding member
3) Developing step of developing the electrostatic charge image formed on the surface of the image holding member as a toner image using a developer
4) Transferring step of transferring the toner image formed on the surface of the image holding member onto a surface of a recording medium
5) Fixing step of fixing the toner image transferred onto the surface of the recording medium
6) Cleaning step of cleaning the surface of the image holding member

The configuration of the image forming apparatus will be described.

The image forming apparatus 100 is a so-called tandem-type color image forming apparatus. The image forming apparatus 100 includes a document image reading device SC, four image forming sections, a transfer device, a conveying device, and a fixing device 50.

The four image forming sections are devices for forming images of four colors of yellow (Y), magenta (M), cyan (C), and black (K), respectively. For example, the four image forming sections are arranged in the order of YMCK from the top in FIG. 7. Each image forming section includes a photoreceptor 1, a charging device 2, an exposure device 3, a developing device 4, a primary transfer roller 5, and a cleaning device 6.

The photoreceptor 1 is, for example, a drum-shaped organic photoreceptor, and the charging device 2 is, for example, a non-contact charging device using corona discharge. The exposure device 3 is, for example, a laser oscillation device, and the developing device 4 is a developing device for a two-component developer that contains a two-component developer of any colors of YMCK. The primary transfer roller 5 is, for example, a charging roller that is freely urged toward the photoreceptor 1 via an intermediate transfer belt 7. The cleaning device 6 is, for example, a blade cleaning device including an elastic blade made of rubber that comes in contact with the surface of the photoreceptor 1.

The transfer device includes an endless intermediate transfer belt 7, a plurality of rollers 8 around which the intermediate transfer belt 7 is stretched, a secondary transfer roller 9, and a cleaning device 10. The rollers 8 include one or more drive rollers, and may further include driven rollers other than the drive rollers. The secondary transfer roller 9 is, for example, a charging roller that forms a nip portion between the secondary transfer roller 9 and the intermediate transfer belt 7 via a conveyed recording medium RM. The cleaning device 10 is, for example, a blade cleaning device including an elastic blade that comes in contact with the surface of the intermediate transfer belt 7.

The conveying device includes a pull-out section 61, conveyance rollers 13 and 15, a registration roller 14, and a winding section 65.

The pull-out section 61 includes an accommodation section 62 that accommodates a roll-shaped recording medium RM, and a conveyance unit 63 for conveying a continuous sheet of the recording medium RM to an upstream portion of the conveying device. The accommodation section 62 includes conveyance rollers 64 for conveying the recording medium RM that has been pulled out. The winding section 65 includes a conveyance unit 66 for conveying the recording medium RM having a toner image formed thereon, and a storage section 67 for storing the recording medium RM conveyed from the conveyance unit 66 in the form of a roll.

A procedure for forming an image will be described.

The document image reading device SC reads image information of a document, converts the image information into image data of each color of YMCK, and sends the image data of the corresponding color to the exposure device 3 described later. In the image forming section, the surface of the rotating photoreceptor 1 is charged by application of a voltage from the charging device 2. The exposure device 3 irradiates the charged surface of the photoreceptor 1 with laser light according to the image data of the corresponding colors of YMCK to form an electrostatic charge image. A toner is supplied from the developing device 4 to the surface of the photoreceptor 1 on which the electrostatic charge image has been formed, and the toner adheres to a portion of the electrostatic charge image, thereby developing the electrostatic charge image.

The toner images of each color of YMCK formed in the image forming sections and carried on the surfaces of the photoreceptors 1 are transferred, by application of voltage from the primary transfer rollers 5, onto the rotating intermediate transfer belt 7 so as to be sequentially superimposed on each other. A combined color toner image is thus formed on the intermediate transfer belt 7. The primary transfer roller 5 may contact the photoreceptor 1 only during the primary transfer. For example, the primary transfer roller 5 in the image forming section for a black image is always in contact with the photoreceptor 1, and the primary transfer rollers 5 for the other colors are in contact with the photoreceptor 1 only during the primary transfer.

Adhered substances such as transfer residual toner on the surface of the photoreceptor 1 after the primary transfer are removed from the surface by the cleaning device 6.

The recording medium RM stored in the accommodation section 62 is pulled out by the conveyance roller 64 and conveyed to the conveyance unit 63. Thereafter, the recording medium RM is conveyed to the secondary transfer roller 9 via the conveyance roller 13 and the registration roller 14. The conveyance roller 13 conveys the recording medium RM to the nip portion of the secondary transfer roller 9, and the registration roller 14 controls the position of the recording medium RM being conveyed. The color toner image on the intermediate transfer belt 7 is transferred onto the recording medium RM by application of voltage from the secondary transfer roller 9. The secondary transfer roller 9 is urged toward the intermediate transfer belt 7, for example, only during the secondary transfer.

Adhered substances such as transfer residual toner on the surface of the intermediate transfer belt 7 after the secondary transfer are removed from the surface by the cleaning device 10.

The color toner image on the recording medium RM is fixed on the surface of the recording medium RM by heat and pressure of the fixing device 50, and the color toner image is formed on the recording medium RM. The recording medium RM on which the color toner image is formed is conveyed to the winding section 65 via a conveyance roller 15. By repeating the above-described steps, toner images are sequentially formed on the recording medium RM.

### 8. Image-Formed Product

The image-formed product of the present embodiment has an image layer on the recording medium, and the image layer contains the toner. The recording medium and the toner are as described above.

In a cross section in a thickness direction of the image formed product of the present embodiment, the image layer has at least one void in a region having a width of 200 μm.

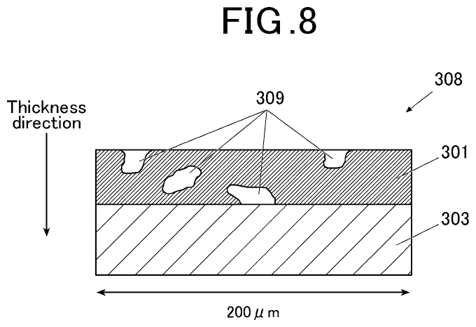

FIG. 8 is a schematic cross-sectional view of an image-formed product 308 in the thickness direction. In the present embodiment, the term “void” refers to a space where no toner exists in the image layer 301 on the recording medium 303. For example, when the cross section of the image-formed product 308 is observed with a scanning electron microscope (SEM), the voids 309 appear darker than the surrounding portions where the toner is present.

In the present embodiment, the image layer has at least one void in a range of 200 μm in width. That is, in the image layer, the distance between the voids is smaller than 200 μm. With this configuration, the image layer has an appropriate number of voids, and charges can be released from the voids. The voids preferably face the surface of the image layer or the interface between the image layer and the recording medium. When the voids face the surface of the image layer, the surface area of the image layer is increased, and charges in the image layer are easily released to the outside of the image-formed product. When the voids face the interface between the image layer and the recording medium, charges in the image layer are easily released to the outside of the image-formed product through the recording medium.

### EXAMPLES

Hereinafter, the present invention will be specifically described with reference to Examples, but the present invention is not limited thereto. In Examples, “part(s)” or “%” means “part(s) by mass” or “% by mass” unless otherwise specified.

In the following Examples, operations were performed at room temperature (25° C.) unless otherwise specified.

### 1. Production of Toner

### (1) Preparation of Styrene-(Meth)acrylic Resin Particle Dispersion Liquid

### (1.1) Preparation of Styrene-(Meth)acrylic Resin Particle Dispersion Liquid (S1)

### (First Stage Polymerization)

The following components were charged into a 5 L reaction vessel equipped with a stirrer, a temperature sensor, a cooling tube, and a nitrogen inlet device. While the inside of the reaction vessel was stirred at a stirring speed of 230 rpm under a nitrogen gas flow, the internal temperature of the reaction vessel was increased to 81° C.

| | | |
|---|---|---|
| Sodium dodecyl sulfate | 8.0 | parts by mass |
| Ion exchange water | 3,000.0 | parts by mass |

After the temperature rise, a solution obtained by dissolving the following components was added to the reaction vessel.

| | | |
|---|---|---|
| Potassium persulfate | 10.0 | parts by mass |
| Ion exchange water | 200.0 | parts by mass |

The liquid temperature in the reaction vessel was set to 81° C. again, and a mixed solution of the following monomers was added dropwise over 1 hour. After the dropwise addition, the mixture was held at the same temperature for 2 hours to prepare a styrene-(meth)acrylic resin particle dispersion liquid (S1-a).

| | | |
|---|---|---|
| Styrene | 470.0 | parts by mass |
| n-Butyl acrylate (acrylic acid n-butyl ester) | 250.0 | parts by mass |
| Methacrylic acid | 78.0 | parts by mass |

### (Second Stage Polymerization)

The following components were charged into a 5 L reaction vessel equipped with a stirrer, a temperature sensor, a cooling tube, and a nitrogen inlet device, and heated to 87° C.

| | | |
|---|---|---|
| Ion exchange water | 970.0 | parts by mass |
| Styrene-(meth)acrylic resin particle dispersion | 34.0 | parts by mass |
| liquid (S1-a) prepared by the first stage | | |
| polymerization (Solid content equivalent) | | |

Next, separately from the mixed liquid in the reaction vessel, the following monomers, chain transfer agent, and release agent were dissolved at 80° C. to obtain a mixed solution.

| | | |
|---|---|---|
| Styrene | 200.0 | parts by mass |
| 2-Ethylhexyl acrylate | 108.0 | parts by mass |
| Methacrylic acid | 75.0 | parts by mass |
| n-Octyl-3-mercaptopropionate | 3.0 | parts by mass |
| (chain transfer agent) | | |
| Behenyl behenate (release agent, | 181.8 | parts by mass |
| melting point 73° C.) | | |

The obtained mixed liquid was subjected to a mixing and dispersing treatment for 15 minutes using a mechanical disperser “CLEARMIX” (manufactured by M Technique Co., Ltd.) having a circulation path to prepare a dispersion liquid containing emulsified particles (oil droplets). The obtained dispersion liquid was added to the 5 L reaction vessel described above.

A solution obtained by dissolving the following components was added to the reaction vessel. Thereafter, the system was heated and stirred at 87° C. for 1 hour to perform polymerization, thereby preparing a styrene-(meth)acrylic resin particle dispersion liquid (S1-b).

| | | |
|---|---|---|
| Potassium persulfate | 4.5 | parts by mass |
| Ion exchange water | 90.0 | parts by mass |

### (Third Stage Polymerization)

A solution obtained by dissolving the following components was added to the styrene-(meth)acrylic resin particle dispersion liquid (S1-b) obtained by the second stage polymerization.

| | |
|---|---|
| Potassium persulfate | 6.0 parts by mass |
| Ion exchange water | 115.0 parts by mass |

A mixed solution of the following monomers and chain transfer agent was added dropwise to the reaction vessel under a temperature condition of 84° C. over 80 minutes.

| | | |
|---|---|---|
| Styrene | 280.0 | parts by mass |
| n-Butyl acrylate (acrylic acid n-butyl ester) | 150.0 | parts by mass |
| Methacrylic acid (MAA) | 66.0 | parts by mass |
| Methyl methacrylate (MMA) | 86.0 | parts by mass |
| n-Octyl-3-mercaptopropionate | 7.0 | parts by mass |

After the completion of the dropwise addition, the mixed solution was heated and stirred for 2 hours for polymerization and then cooled to 28° C. to prepare a styrene-(meth)acrylic resin particle dispersion liquid (S1) having a solid content of 25% by mass. The vinyl polymer particles had a median diameter of 120 nm and a weight average molecular weight Mw of 31,000. Hereinafter, in order to distinguish the dispersion liquids respectively obtained in the first stage polymerization, the second stage polymerization, and the third stage polymerization, the dispersion liquid obtained in the third stage polymerization is also referred to as a styrene-(meth)acrylic resin particle dispersion liquid (S1-c).

### (1.2) Preparation of Styrene-(Meth)Acrylic Resin Particle Dispersion Liquids (S2) to (S7) and (S10) to (S12)

Dispersion liquids (S2) to (S7) and (S10) to (S12) were prepared in the same procedure as the preparation of the dispersion liquid (S1) except that the amount of the release agent added was changed to the amount described in Table I in the second stage polymerization in which the dispersion liquid (S1-b) was prepared.

### (1.3) Preparation of Styrene-(Meth)Acrylic Resin Particle Dispersion Liquids (S8) and (S9)

Dispersion liquids (S8) and (S9) were prepared in the same procedure as the preparation of the dispersion liquid (S1) except that the amount of the release agent added, the amount of the monomer added and the type of the monomer were changed to the amounts described in Table I and Table II in the second stage polymerization in which the dispersion liquid (S1-b) was prepared and the third stage polymerization in which the dispersion liquid (S1-c) was prepared. In the dispersion liquid (S9), stearyl methacrylate was used as the monomer in the third stage polymerization instead of methyl methacrylate (MMA).

Table I and Table II show the compositions of monomers in the resins contained in the styrene-(meth)acrylic resin particle dispersion liquids (S1) to (S12). The “release agent” in Table I is specifically behenyl behenate.

TABLE I

| | | | | Second stage polymerization | | | |
|---|---|---|---|---|---|---|---|
| | First stage polymerization | | | | | | Release |
| | St | BA | MAA | St | 2-EHA | MAA | agent |
| Dispersion | [parts by | [parts by | [parts by | [parts by | [parts by | [parts by | [parts by |
| liquid No. | mass] | mass] | mass] | mass] | mass] | mass] | mass] |
| S1 | 470.0 | 250.0 | 78.0 | 200.0 | 108.0 | 75.0 | 181.8 |
| S2 | 470.0 | 250.0 | 78.0 | 200.0 | 108.0 | 75.0 | 242.4 |
| S3 | 470.0 | 250.0 | 78.0 | 200.0 | 108.0 | 75.0 | 363.6 |
| S4 | 470.0 | 250.0 | 78.0 | 200.0 | 108.0 | 75.0 | 727.2 |
| S5 | 470.0 | 250.0 | 78.0 | 200.0 | 108.0 | 75.0 | 0.0 |
| S6 | 470.0 | 250.0 | 78.0 | 200.0 | 108.0 | 75.0 | 134.0 |
| S7 | 470.0 | 250.0 | 78.0 | 200.0 | 108.0 | 75.0 | 238.8 |
| S8 | 470.0 | 250.0 | 78.0 | 255.0 | 108.0 | 75.0 | 181.8 |
| S9 | 470.0 | 250.0 | 78.0 | 200.0 | 108.0 | 75.0 | 242.4 |
| S10 | 470.0 | 250.0 | 78.0 | 200.0 | 108.0 | 75.0 | 161.6 |
| S11 | 470.0 | 250.0 | 78.0 | 200.0 | 108.0 | 75.0 | 238.4 |
| S12 | 470.0 | 250.0 | 78.0 | 200.0 | 108.0 | 75.0 | 85.3 |

TABLE II

| | Third stage polymerization | | | | |
|---|---|---|---|---|---|
| | | | | | Stearyl |
| | St | BA | MAA | MMA | methacrylate |
| Dispersion | [parts by | [parts by | [parts by | [parts by | [parts by |
| liquid No. | mass] | mass] | mass] | mass] | mass] |
| S1 | 280.0 | 150.0 | 66.0 | 86.0 | 0.0 |
| S2 | 280.0 | 150.0 | 66.0 | 86.0 | 0.0 |
| S3 | 280.0 | 150.0 | 66.0 | 86.0 | 0.0 |
| S4 | 280.0 | 150.0 | 66.0 | 86.0 | 0.0 |
| S5 | 280.0 | 150.0 | 66.0 | 86.0 | 0.0 |
| S6 | 280.0 | 150.0 | 66.0 | 86.0 | 0.0 |
| S7 | 280.0 | 150.0 | 66.0 | 86.0 | 0.0 |
| S8 | 325.0 | 120.0 | 56.0 | 76.0 | 0.0 |
| S9 | 280.0 | 150.0 | 66.0 | 0.0 | 86.0 |
| S10 | 280.0 | 150.0 | 66.0 | 86.0 | 0.0 |
| S11 | 280.0 | 150.0 | 66.0 | 86.0 | 0.0 |
| S12 | 280.0 | 150.0 | 66.0 | 86.0 | 0.0 |

### (2) Preparation of Crystalline Polyester Particle Dispersion Liquid

### (2.1) Preparation of Crystalline Polyester Particle Dispersion Liquid (PC1)

(2.1.1) Synthesis of Crystalline Polyester (pC1)

The following monomers were placed in a four-necked flask equipped with a nitrogen inlet tube, a dewatering tube, a stirrer, and a thermocouple, and were heated to 190° C. to be dissolved.

### Carboxylic Acid

| | |
|---|---|
| Tetradecanedioic acid | 450.0 parts by mass |

### Alcohol

1,6-Hexanediol 266.0 parts by mass

Next, the following components as an esterification catalyst were charged into the four-necked flask, and the temperature was increased to 240° C. Thereafter, the reaction was carried out under atmospheric pressure (101.3 kPa) for 5 hours and further under reduced pressure (8 kPa) for 1 hour.

| | |
|---|---|
| Tetra-n-butyl titanate (tetrabutyl orthotitanate; Ti(O—n-Bu)₄) | 0.8 parts by mass |

Next, the inside of the four-necked flask was cooled to 200° C., and then the mixture was allowed to react under reduced pressure (20 kPa) for 1 hour to obtain a crystalline polyester (pC1). The obtained crystalline polyester (pC1) had a weight average molecular weight (Mw) of 20,700 and a melting point (mp) of 74° C.

### (2.1.2) Preparation of Crystalline Polyester Particle Dispersion Liquid (PC1)

The following components were dissolved.

| | |
|---|---|
| Crystalline Polyester (pC1) obtained above | 100.0 parts by mass |
| Ethyl acetate (manufactured by KANTO | 400.0 parts by mass |
| CHEMICAL CO., INC.) | |

The obtained solution and the following solution which had been prepared in advance were mixed.

Sodium lauryl sulfate solution having concentration of 0.26% by mass 638.0 parts by mass

While stirring the obtained mixed solution, an ultrasonic dispersion treatment was performed by an ultrasonic homogenizer “US-150T” (manufactured by NIHONSEIKI KAISHA LTD.) at V-LEVEL 300 μA for 30 minutes.

Thereafter, ethyl acetate was completely removed while stirring for 3 hours under reduced pressure using a diaphragm vacuum pump “V-700” (manufactured by BUCHI Labortechnik GmbH) in a state of being heated to 40° C., thereby preparing a crystalline polyester particle dispersion liquid (CP1). The volume-based median diameter of the crystalline polyester particles in the dispersion liquid was 150 nm.

### (2.2) Preparation of Crystalline Polyester Particle Dispersion Liquid (PC2)

In the synthesis of the crystalline polyester (pC2), the carboxylic acid and the alcohol were changed to the following components. Except this, the crystalline polyester particle dispersion liquid (PC2) was prepared in the same procedure as the preparation of the crystalline polyester particle dispersion liquid (PC1).

### Carboxylic Acid

| | |
|---|---|
| Tetradecanedioic acid | 250.0 parts by mass |
| Stearic acid | 200.0 parts by mass |

### Alcohol

1,6-Hexanediol 266.0 parts by mass

### (2.3) Preparation of Crystalline Polyester Particle Dispersion Liquid (PC3)

In the synthesis of the crystalline polyester (pC3), the carboxylic acid and the alcohol were changed to the following components. Except this, the crystalline polyester particle dispersion liquid (PC3) was prepared in the same procedure as the preparation of the crystalline polyester particle dispersion liquid (PC1).

### Carboxylic Acid

| | |
|---|---|
| Tetradecanedioic acid | 442.0 parts by mass |

### Alcohol

1,4-Butanediol 287.0 parts by mass

### (2.4) Preparation of Crystalline Polyester Particle Dispersion Liquid (PC4)

(2.4.1) Synthesis of Crystalline Polyester (pC4-a)

The inside of a four-necked flask equipped with a nitrogen inlet tube, a dewatering tube, a stirrer, and a thermocouple and having an internal volume of 10 L was purged with nitrogen gas, and the following components were charged into the four-necked flask. Note that the hydrocarbon wax here functioned as a dispersant.

| | | |
|---|---|---|
| Bisphenol A propylene oxide 2.2 molar adduct | 3253.0 | parts by mass |
| Terephthalic acid | 1003.0 | parts by mass |
| Tin(II) di(2-ethylhexanoate) | 25.0 | parts by mass |
| 3,4,5-trihydroxybenzoic acid | 2.5 | parts by mass |
| Hydrocarbon wax “PARACOL 6490” | 394.0 | parts by mass |
| (manufactured by NIPPON SEIRO CO., LTD., | | |
| acid value 18 mgKOH/g, hydroxyl value | | |
| 97 mgKOH/g) | | |

Under a nitrogen gas atmosphere, the temperature was increased to 235° C. while stirring the mixture, and after holding at 235° C. for 8 hours, the pressure in the flask was reduced and held at 8 kPa for 1 hour. Thereafter, the inside of the flask was cooled to 160° C. and returned to atmospheric pressure, and then held at 160° C. while adding dropwise a mixture of the following components over 3 hours.

| | |
|---|---|
| Styrene | 2139.0 parts by mass |
| Stearyl methacrylate | 535.0 parts by mass |
| Acrylic acid | 107.0 parts by mass |
| Dibutyl peroxide | 321.0 parts by mass |

Thereafter, the inside of the flask was held at 160° C. for 30 minutes and then heated to 200° C., and the pressure in the flask was reduced and held at 8 kPa for 1 hour. Thereafter, the pressure in the flask was returned to atmospheric pressure, and then the temperature in the flask was cooled to 190° C., and the following components were added.

| | | |
|---|---|---|
| Fumaric acid | 129.0 | parts by mass |
| Sebacic acid | 94.0 | parts by mass |
| Trimellitic anhydride | 214.0 | parts by mass |
| 4-tert-Butylcatechol | 2.5 | parts by mass |

The temperature in the flask was increased to 210° C. at 10° C./hr, and then a reaction was carried out at 4 kPa until the desired softening point was reached, thereby obtaining a crystalline polyester (pC4-a).

(2.4.2) Synthesis of Crystalline Polyester (pC4-b)

The inside of a four-necked flask equipped with a nitrogen inlet tube, a dewatering tube, a stirrer, and a thermocouple and having an internal volume of 10 L was purged with nitrogen gas, and the following components were charged into the four-necked flask.

| | |
|---|---|
| 1,10-decanediol | 3416.0 parts by mass |
| Sebacic acid | 4084.0 parts by mass |

The temperature in the flask was increased to 135° C. while stirring the mixture, and after holding at 135° C. for 3 hours, and then the temperature was increased from 135° C. to 200° C. over 10 hours. Thereafter, the following components were added, and the temperature was further held at 200° C. for 1 hour. Then, the pressure in the flask was reduced and held at a reduced pressure of 8.3 kPa for 1 hour to obtain a crystalline polyester (pC4-b).

| | |
|---|---|
| Tin(II) di(2-ethylhexanoate) | 23.0 parts by mass |

### (2.4.3) Preparation of Crystalline Polyester Particle Dispersion Liquid (PC4)

Into a vessel equipped with a stirrer, a reflux condenser, a dropping funnel, a thermometer, and a nitrogen inlet tube and having an internal volume of 3 L, the following components were charged, and the resin was dissolved at 73° C. over 2 hours.

| | | |
|---|---|---|
| Crystalline polyester (pC4-a) | 210.0 | parts by mass |
| Crystalline polyester (pC4-b) | 90.0 | parts by mass |
| Methyl ethyl ketone | 300.0 | parts by mass |
| Deionized water | 49.0 | parts by mass |

A 5% by mass aqueous sodium hydroxide solution was added to the obtained solution so that the neutralization degree was 50 mol % with respect to the acid value of the resin, and the mixture was stirred for 30 minutes.

Next, while the temperature in the vessel was held at 73° C., 600 g of deionized water was added over 60 minutes with stirring at 280 r/min (circumferential speed 88 m/min) to perform phase inversion emulsification. While the temperature in the vessel was continuously held at 73° C., methyl ethyl ketone was distilled off under reduced pressure to obtain an aqueous dispersion. Thereafter, the aqueous dispersion was cooled to 30° C. while stirring at 280 r/min (circumferential speed 63 m/min), and then deionized water was added so that the solid content concentration was 20% by mass to obtain a crystalline polyester particle dispersion liquid (PC4).

Table III shows the compositions of the crystalline polyester particle dispersion liquids (PC1) to (PC4). As shown in Table III, each of the dispersion liquids (PC1) to (PC3) contains one kind of unmodified polyester. The dispersion liquid (PC4) contains two kinds of resins, that is, a polyester modified with a styrene-(meth)acrylic resin, and an unmodified polyester. Note that the term “unmodified” herein means that the crystalline polyester is not modified with a compound other than the monomer forming the repeating structure.

TABLE III

| Dispersion | Crystalline polyester | | | |
|---|---|---|---|---|
| liquid No. | Type 1 | | Type 2 | |
| PC1 | pC1 | Unmodified polyester | — | — |
| PC2 | pC2 | Unmodified polyester | — | — |
| PC3 | pC3 | Unmodified polyester | — | — |
| PC4 | pC4-a | Styrene-acrylic | pC4-b | Unmodified |
| | | resin-modified polyester | | polyester |

### (3) Preparation of Amorphous Polyester Particle Dispersion Liquid

### (3.1) Preparation of Amorphous Polyester Particle Dispersion Liquid (P1)

### (3.1.1) Synthesis of Amorphous Polyester (p1)

The following monomers of the amorphous polyester resin were placed in a four-necked flask equipped with a nitrogen inlet tube, a dewatering tube, a stirrer, and a thermocouple, and were heated to 170° C. to be dissolved.

| | | |
|---|---|---|
| Bisphenol A ethylene oxide 2 molar adduct | 50.2 | parts by mass |
| Bisphenol A propylene oxide 2 molar adduct | 249.8 | parts by mass |
| Terephthalic acid | 120.1 | parts by mass |
| Dodecenyl succinic acid | 46.0 | parts by mass |

The mixed liquid in the dropping funnel was added dropwise to the four flask over 90 minutes while being stirred, and was ripened for 60 minutes. After the ripening, the unreacted monomer was removed under reduced pressure (8 kPa).

Thereafter, the following components were charged into the flask as esterifying catalysts, the temperature was increased to 235° C., and the reaction was carried out under ordinary pressure (101.3 kPa) for 5 hours and further under reduced pressure (8 kPa) for 1 hour.

| | |
|---|---|
| Tetra-n-butyl titanate (tetrabutyl orthotitanate; | 0.4 parts by mass |
| Ti(O-n-Bu)₄) | |

Next, the inside of the flask was cooled to 200° C., and a reaction was carried out under reduced pressure (20 kPa), followed by desolvation, to obtain amorphous polyester (p1). The obtained amorphous polyester (p1) had a weight average molecular weight (Mw) of 22,000.

### (3.1.2) Preparation of Amorphous Polyester Particle Dispersion Liquid (P1)

The following components were dissolved.

| | |
|---|---|
| Amorphous Polyester (p1) obtained above | 100.0 parts by mass |
| Ethyl acetate (manufactured by KANTO | 400.0 parts by mass |
| CHEMICAL CO., INC.) | |

The obtained solution and the following solution which had been prepared in advance were mixed.

| | |
|---|---|
| Sodium lauryl sulfate solution having | 638.0 parts by mass |
| concentration of 0.26% by mass | |

While stirring the obtained mixed solution, an ultrasonic dispersion treatment was performed by an ultrasonic homogenizer “US-150T” (manufactured by NIHONSEIKI KAISHA LTD.) at V-LEVEL 300 μA for 30 minutes.

Thereafter, ethyl acetate was completely removed while stirring for 3 hours under reduced pressure using a diaphragm vacuum pump “V-700” (manufactured by BUCHI Labortechnik GmbH) in a state of being heated to 40° C., thereby preparing an amorphous polyester particle dispersion liquid (P1) having a solid content concentration of 13.5% by mass. The volume-based median diameter of the crystalline polyester particles in the dispersion liquid was 120 nm.

### (3.2) Preparation of Amorphous Polyester Particle Dispersion Liquid (P2)

### (3.2.1) Synthesis of Amorphous Polyester (p2)

The inside of a four-necked flask equipped with a nitrogen inlet tube, a dewatering tube, a stirrer, and a thermocouple and having an internal volume of 10 L was purged with nitrogen gas, and the following components were charged into the four-necked flask.

| | | |
|---|---|---|
| Bisphenol A propylene oxide 2.2 molar adduct | 5001.0 | parts by mass |
| Terephthalic acid | 1788.0 | parts by mass |
| Tin(II) di(2-ethylhexanoate) | 30.0 | parts by mass |
| 3,4,5-trihydroxybenzoic acid | 3.0 | parts by mass |

Under a nitrogen gas atmosphere, the temperature was increased to 235° C. while stirring the mixture, and after holding at 235° C. for 8 hours, the pressure in the flask was reduced and held at −8 kPa (G) for 1 hour. Thereafter, the pressure in the flask was returned to atmospheric pressure, and then the temperature in the flask was cooled to 180° C., and the following components were added.

| | |
|---|---|
| Fumaric acid | 179.0 parts by mass |
| Dodecenyl succinic anhydride | 206.0 parts by mass |
| Trimellitic anhydride | 325.0 parts by mass |
| 4-tert-Butylcatechol | 3.8 parts by mass |

The temperature in the flask was increased to 220° C. at 10° C./hr, and then the pressure in the flask was reduced, and a reaction was carried out at −10 kPa (G) until the desired softening point was reached, thereby obtaining an amorphous polyester (p2).

### (3.2.2) Preparation of Amorphous Polyester Particle Dispersion Liquid (P2)

Into a vessel equipped with a stirrer, a reflux condenser, a dropping funnel, a thermometer, and a nitrogen inlet tube and having an internal volume of 3 L, the following components were charged, and the resin was dissolved at 73° C. over 2 hours.

| | |
|---|---|
| Amorphous Polyester (p2) obtained above | 300.0 parts by mass |
| Methyl ethyl ketone | 300.0 parts by mass |
| Deionized water | 41.0 parts by mass |

A 5% by mass aqueous sodium hydroxide solution was added to the obtained solution so that the neutralization degree was 60 mol % with respect to the acid value of the amorphous polyester (p2), and the mixture was stirred for 30 minutes.

Next, while the temperature in the vessel was held at 73° C., 600 g of deionized water was added over 60 minutes with stirring at 200 r/min (circumferential speed 63 m/min) to perform phase inversion emulsification. While the temperature in the vessel was continuously held at 73° C., methyl ethyl ketone was distilled off under reduced pressure to obtain an aqueous dispersion. Thereafter, the aqueous dispersion liquid was cooled to 30° C. while stirring at 280 r/min (circumferential speed 88 m/min), and then deionized water was added so that the solid content concentration was 20% by mass to obtain an amorphous polyester particle dispersion liquid (P2).

### (4) Preparation of Release Agent Particle Dispersion Liquid

### (4.1) Preparation of Release Agent Particle Dispersion Liquid (W1)

### (4.1.1) Synthesis of Resin (y1)

The inside of a four-necked flask equipped with a nitrogen inlet tube, a dewatering tube, a stirrer, and a thermocouple and having an internal volume of 10 L was purged with nitrogen gas, and the following components were charged into the four-necked flask.

| | | |
|---|---|---|
| Bisphenol A propylene oxide 2.2 molar adduct | 4313.0 | parts by mass |
| Terephthalic acid | 818.0 | parts by mass |
| Succinic acid | 727.0 | parts by mass |
| Tin(II) di(2-ethylhexanoate) | 30.0 | parts by mass |
| 3,4,5-trihydroxybenzoic acid | 3.0 | parts by mass |

Under a nitrogen gas atmosphere, the temperature in the flask was increased to 235° C. while stirring the mixture, and after holding at 235° C. for 5 hours, the pressure in the flask was reduced and held at 8 kPa for 1 hour. Thereafter, the pressure in the flask was returned to atmospheric pressure, and then the temperature in the flask was cooled to 160° C., and then held at 160° C. while adding dropwise a mixture of the following components over 1 hour.

| | |
|---|---|
| Styrene | 2756.0 parts by mass |
| Stearyl methacrylate | 689.0 parts by mass |
| Acrylic acid | 142.0 parts by mass |
| Dibutyl peroxide | 413.0 parts by mass |

Thereafter, the temperature in the flask was held at 160° C. for 30 minutes, and then increased to 200° C. Next, the pressure in the flask was further reduced, and the reaction was carried out at 8 kPa until a desired softening point was reached, thereby obtaining a resin (y1) as an amorphous polyester.

### (4.1.2) Preparation of Resin Particle Dispersion Liquid (Y1)

Into a vessel equipped with a stirrer, a reflux condenser, a dropping funnel, a thermometer, and a nitrogen inlet tube and having an internal volume of 3 L, the following components were charged, and the resin was dissolved at 73° C. over 2 hours.

| | |
|---|---|
| Resin (y1) | 200.0 parts by mass |
| Methyl ethyl ketone | 200.0 parts by mass |

A 5% by mass aqueous sodium hydroxide solution was added to the obtained solution so that the neutralization degree was 60 mol % with respect to the acid value of the resin (y1), and the mixture was stirred for 30 minutes.

Next, while the temperature in the vessel was held at 73° C., 700 g of deionized water was added over 50 minutes with stirring at 280 r/min (circumferential speed 88 m/min) to perform phase inversion emulsification. While the temperature in the vessel was continuously held at 73° C., methyl ethyl ketone was distilled off under reduced pressure to obtain an aqueous dispersion. Thereafter, the aqueous dispersion was cooled to 30° C. while stirring at 280 r/min (circumferential speed 88 m/min), and then deionized water was added so that the solid content concentration was 20% by mass to obtain a resin particle dispersion liquid (Y1).

### (4.1.3) Preparation of Release Agent Particle Dispersion Liquid (W1)

The following components were added to a beaker having an internal volume of 1 L. The inside of the beaker was held at the temperature in a range of 90 to 95° C., and the following components were melted and stirred to obtain a molten mixture.

| | |
|---|---|
| Deionized water | 545.4 parts by mass |
| Resin particle dispersion liquid (Y1) | 390.9 parts by mass |
| Paraffin wax “HNP-9” (manufactured by NIPPON | 181.8 parts by mass |
| SEIRO CO., LTD., melting point 75° C.) | |

The obtained molten mixture was further subjected to a dispersion treatment for 20 minutes using an ultrasonic homogenizer “US-600T” (manufactured by NIHONSEIKI KAISHA LTD.) while being held at a temperature in a range of 90 to 95° C. Thereafter, the molten mixture was cooled to room temperature (25° C.). Deionized water was added to adjust the solid content concentration to 20% by mass, thereby obtaining a release agent particle dispersion liquid (W1). The volume median particle size D50 of the release agent particles in the dispersion liquid is 0.47 μm, and the CV value thereof is 27%.

### (4.2) Preparation of Release Agent Particle Dispersion Liquid (W2)

The following components were added to a beaker having an internal volume of 1 L. The inside of the beaker was held at the temperature in a range of 90 to 95° C., and the following components were melted and stirred to obtain a molten mixture.

| | |
|---|---|
| Deionized water | 545.4 parts by mass |
| Resin particle dispersion liquid (Y1) | 390.9 parts by mass |
| Behenyl behenate | 181.8 parts by mass |

The obtained molten mixture was further subjected to a dispersion treatment for 20 minutes using an ultrasonic homogenizer “US-600T” (manufactured by NIHONSEIKI KAISHA LTD.) while being held at a temperature in a range of 90 to 95° C. Thereafter, the molten mixture was cooled to room temperature (25° C.). Deionized water was added to adjust the solid content concentration to 20% by mass, thereby obtaining a release agent particle dispersion liquid (W2). The volume median particle size D50 of the release agent particles in the dispersion liquid is 0.43 μm, and the CV value thereof is 25%.

### (5) Preparation of Coloring Agent Particle Dispersion Liquid (Cy1)

The following components were mixed and dispersed using a high-pressure impact disperser Ultimizer “HJP30006” (manufactured by Sugino Machine Limited) to obtain a coloring agent particle dispersion liquid (Cy1). The median diameter of the particles of the obtained coloring agent was 150 nm.

| | | |
|---|---|---|
| Cyan pigment (manufactured by Dainichiseika | 420.0 | parts by mass |
| Color & Chemicals Mfg. Co., Ltd., Pigment | | |
| Blue 15:3 (copper phthalocyanine) | | |
| Anionic surfactant “NEOGEN (R) R” | 80.0 | parts by mass |
| (manufactured by DKS Co. Ltd.) | | |
| Ion exchange water | 1600.0 | parts by mass |

### (6) Preparation of Toner Base Particles

### (6.1) Preparation of Toner Base Particles (1)

The following components were charged into a reaction vessel equipped with a stirrer, a temperature sensor, and a cooling tube.

| | | |
|---|---|---|
| Styrene-(meth)acrylic resin particle | 1763.0 | parts by mass |
| dispersion liquid (S1) (Solid content | | |
| equivalent: resin) | | |
| (Solid content equivalent: release agent) | 181.8 | parts by mass |
| Ion exchange water | 2,000.0 | parts by mass |

At room temperature (25° C.), a 5 mol/L aqueous sodium hydroxide solution was added to the vessel to adjust the pH in the vessel to 10. Then, the following components were charged into the vessel.

| | |
|---|---|
| Coloring agent particle dispersion liquid (Cy1) | 210.0 parts by mass |
| (Solid content equivalent) | |

Next, the temperature in the vessel was set to 30° C., and a solution obtained by dissolving the following components was added over 10 minutes while the content in the vessel was stirred.

| | |
|---|---|
| Magnesium chloride | 60.0 parts by mass |
| Ion exchange water | 60.0 parts by mass |

The reaction liquid in the vessel was left for 3 minutes, and then the temperature was increased to 80° C. over 60 minutes. Thereafter, the stirrer was set to 300 rpm, and the mixture was stirred and held for 30 minutes. Thereafter, while the stirring speed was adjusted so that the growth rate of the particle size was 0.01 μm/min, the particles were grown until the volume-based median diameter measured by Coulter Multisizer 4e (manufactured by Beckman Coulter, Inc.) reached the target particle size of 6.0 μm. Note that the particle size growth at the setting of 80° C. was performed here, but it was confirmed that the particle size growth can be performed even at a setting temperature other than 80° C., provided that the temperature is higher than the designed glass transition temperature (Tg) of the styrene-(meth)acrylic resin by a range of 30 to 40° C.

Next, the following components were charged into the vessel over 30 minutes.

| | |
|---|---|
| Amorphous polyester particle dispersion liquid (P1) | 440.8 parts by mass |
| (Solid content equivalent) | |

When the supernatant of the reaction liquid became transparent, a solution obtained by dissolving the following components was added to stop the growth of the particle size.

| | |
|---|---|
| Sodium chloride | 250.0 parts by mass |
| Ion exchange water | 860.0 parts by mass |

Next, the reaction liquid was stirred at 80° C. with setting the stirrer to 300 rpm, to allow fusion of the particles to proceed until the average circularity of the toner base particles became 0.970, and then the reaction liquid was cooled to lower the liquid temperature to 30° C. or lower.

Next, solid-liquid separation was performed, the dehydrated toner cake was redispersed in ion exchange water, and an operation of solid-liquid separation was repeated three times for washing. After the washing, the resultant was dried at 40° C. for 24 hours to obtain toner base particles (1).

### (6.2) Preparation of Toner Base Particles (2)

The following components were charged into a reaction vessel equipped with a stirrer, a temperature sensor, and a cooling tube.

### Styrene-(Meth)Acrylic Resin Particle Dispersion Liquid (S1)

| | | |
|---|---|---|
| (Solid content equivalent: resin) | 1322.4 | parts by mass |
| (Solid content equivalent: release agent) | 181.8 | parts by mass |
| Ion exchange water | 2,000.0 | parts by mass |

At room temperature (25° C.), a 5 mol/L aqueous sodium hydroxide solution was added to the vessel to adjust the pH to 10. Then, the following components were charged into the vessel.

Coloring agent particle dispersion liquid (Cy1) (Solid content equivalent) 210.0 parts by mass

Next, the temperature in the vessel was set to 30° C., and a solution obtained by dissolving the following components was added over 10 minutes while the content in the vessel was stirred.

| | |
|---|---|
| Magnesium chloride | 60.0 parts by mass |
| Ion exchange water | 60.0 parts by mass |

The reaction liquid in the vessel was left for 3 minutes, and then the temperature was increased to 80° C. over 60 minutes. After reaching 80° C., the following components were charged into the vessel over 20 minutes. During the charging, the stirrer was set to 300 rpm.

| | |
|---|---|
| Crystalline polyester particle dispersion liquid (PC1) | 440.8 parts by mass |
| (Solid content equivalent) | |

Thereafter, while the stirring speed was adjusted so that the growth rate of the particle size was 0.01 μm/min, the particles were grown until the volume-based median diameter measured by Coulter Multisizer 4e (manufactured by Beckman Coulter, Inc.) reached the target particle size of 6.0 μm.

Next, the following components were charged into the vessel over 30 minutes.

| | |
|---|---|
| Amorphous polyester particle dispersion liquid (P1) | (Solid content equivalent) 440.8 parts by mass |

When the supernatant of the reaction liquid became transparent, a solution obtained by dissolving the following components was added to stop the growth of the particle size.

| | |
|---|---|
| Sodium chloride | 250.0 parts by mass |
| Ion exchange water | 860.0 parts by mass |

Next, the reaction liquid was stirred at 80° C. with setting the stirrer to 300 rpm, to allow fusion of the particles to proceed until the average circularity of the toner base particles became 0.970, and then the reaction liquid was cooled to lower the liquid temperature to 30° C. or lower.

Next, solid-liquid separation was performed, the dehydrated toner cake was redispersed in ion exchange water, and an operation of solid-liquid separation was repeated three times for washing. After the washing, the resultant was dried at 40° C. for 24 hours to obtain toner base particles (2).

### (6.3) Production of Toner Base Particles (3), (4), (6) to (9), (11), (12), and (15)

The type and content of the various resin particle dispersion liquids were changed as described in Table IV. Except this, the respective toner base particles were prepared in the same procedure as the preparation of the toner base particles (2).

### (6.4) Preparation of Toner Base Particles (5)

The following components were charged into a reaction vessel equipped with a stirrer, a temperature sensor, and a cooling tube.

| | |
|---|---|
| Styrene-(meth)acrylic resin particle dispersion liquid (S5) | (Solid content equivalent: resin) 110.2 parts by mass |
| Ion exchange water | 2,000.0 parts by mass |

At room temperature (25° C.), a 5 mol/L aqueous sodium hydroxide solution was added to the vessel to adjust the pH to 10. Then, the following components were charged into the vessel.

| | |
|---|---|
| Coloring agent particle dispersion liquid (Cy1) | (Solid content equivalent) 210.0 parts by mass |
| Release agent particle dispersion liquid (W2) | (Solid content equivalent) 181.8 parts by mass |

Note that the mass in solid content equivalent in the release agent particle dispersion liquid (W2) includes only the mass of the release agent and does not include the mass of the resin (y1).

Next, the temperature in the vessel was set to 30° C., and a solution obtained by dissolving the following components was added over 10 minutes while the content in the vessel was stirred.

| | |
|---|---|
| Magnesium chloride | 60.0 parts by mass |
| Ion exchange water | 60.0 parts by mass |

The reaction liquid in the vessel was left for 5 minutes, and then, the following components were charged into the vessel over 50 minutes.

| | |
|---|---|
| Crystalline polyester particle dispersion liquid (PC1) | (Solid content equivalent) 1653.0 parts by mass |

After completion of the addition, the reaction liquid in the vessel was heated to 80° C. over 60 minute. After reaching 80° C., the stirrer was set to 300 rpm, and the mixture was stirred and held for 30 minutes. Thereafter, while the stirring speed was adjusted so that the growth rate of the particle size was 0.01 μm/min, the particles were grown until the volume-based median diameter measured by Coulter Multisizer 4e (manufactured by Beckman Coulter, Inc.) reached the target particle size of 6.0 μm.

Next, the following components were charged into the vessel over 30 minutes.

| | |
|---|---|
| Amorphous polyester particle dispersion liquid (P1) | (Solid content equivalent) 440.8 parts by mass |

When the supernatant of the reaction liquid became transparent, a solution obtained by dissolving the following components was added to stop the growth of the particle size.

| | |
|---|---|
| Sodium chloride | 250.0 parts by mass |
| Ion exchange water | 860.0 parts by mass |

Next, the temperature of the reaction liquid was increased and the reaction liquid was stirred in a state of 80° C. to allow fusion of the particles to proceed until the average circularity of the toner base particles became 0.970, and then the reaction liquid was cooled to lower the liquid temperature to 30° C. or lower.

Next, solid-liquid separation was performed, the dehydrated toner cake was redispersed in ion exchange water, and an operation of solid-liquid separation was repeated three times for washing. After the washing, the resultant was dried at 40° C. for 24 hours to obtain toner base particles (5).

### (6.5) Preparation of Toner Base Particles (10) and (14)

The type and content of the various resin particle dispersion liquids were changed as described in Table IV. Except this, the toner base particles (10) and (14) were prepared in the same procedure as in the preparation of the toner base particles (1).

### (6.6) Preparation of Toner Base Particles (13)

The following components were charged into a reaction vessel equipped with a stirrer, a temperature sensor, and a cooling tube, and mixed at room temperature (25° C.).

| | |
|---|---|
| Crystalline polyester particle dispersion liquid (PC4) | (Solid content equivalent) 1961.4 parts by mass |
| Release agent particle dispersion liquid (W1) | (Solid content equivalent) 181.8 parts by mass |
| Coloring agent particle dispersion liquid (Cy1) | (Solid content equivalent) 210.0 parts by mass |
| 15% by mass aqueous sodium dodecylbenzenesulfonate “NEOPELEX G-15” | 20.0 parts by mass |
| (manufactured by Kao Corp., anionic surfactant) | |

Note that the mass in solid content equivalent in the release agent particle dispersion liquid (W1) includes only the mass of the release agent and does not include the mass of the resin (y1).

A 4.8% by mass aqueous potassium hydroxide solution was added to an aqueous solution of 80 parts by mass of ammonium sulfate dissolved in 1236 parts by mass of deionized water to prepare a solution of pH 8.6. This solution was added dropwise at 25° C. over 10 minutes while stirring the mixture in the reaction vessel. Thereafter, the temperature in the reaction vessel was increased to 59° C. over 2 hours, and the temperature was held at 59° C. until the volume median particle size D50 of the aggregated particles became 5.5 μm, to obtain a dispersion liquid of aggregated particles (1).

While the temperature of the dispersion liquid of aggregated particles (1) was held at 59° C., the following components were added dropwise thereto at a rate of 0.7 mL/min to obtain a dispersion liquid of aggregated particles (2).

| | |
|---|---|
| Amorphous polyester particle dispersion liquid (P2) | (Solid content equivalent) 242.4 parts by mass |

To the obtained dispersion liquid of aggregated particles (2), a solution obtained by mixing the following components was added.

| | |
|---|---|
| Sodium polyoxyethylene lauryl ether sulfate “EMAL E-27C” (manufactured by Kao Corp., anionic | 36.0 parts by mass |
| surfactant, effective concentration 27% by mass). | |
| Deionized water | 313.0 parts by mass |
| 0.1 mol/L aqueous sulfuric acid solution | 40.0 parts by mass |

The dispersion liquid of the aggregated particles (2) was heated to 80° C. over 1 hour and held at 80° C. for 30 minutes, then the following components were added thereto, and the mixture was further held at 80° C. for 15 minutes.

0.1 mol/L aqueous sulfuric acid solution 20.0 parts by mass

Thereafter, the following components were added to the dispersion liquid of the aggregated particles (2), and the mixture was held at 80° C. until the circularity reached 0.970, thereby obtaining a dispersion liquid of fused particles in which the aggregated particles were fused.

0.1 mol/L aqueous sulfuric acid solution 20.0 parts by mass

Next, solid-liquid separation was performed, the dehydrated toner cake was redispersed in ion exchange water, and an operation of solid-liquid separation was repeated three times for washing. After the washing, the resultant was dried at 40° C. for 24 hours to obtain toner base particles (13).

### (Mass Ratio of Styrene-(Meth)Acrylic Resin to Polyester)

The crystalline polyester (pC4) was composed of the crystalline polyesters (pC4-a) and (pC4-b). The crystalline polyester (pC4-a) was a crystalline polyester modified with the styrene-(meth)acrylic resin, and was composed of a styrene-(meth)acrylic resin component and a polyester component. In the crystalline polyester (pC4-a), the mass ratio of the styrene-(meth)acrylic resin to the polyester was 35:65.

The mass ratio of the crystalline polyester (pC4-a) to the crystalline polyester (pC4-b) in the crystalline polyester (pC4) is 210:90. Therefore, the mass ratio of the styrene-(meth)acrylic resin to the polyester in the crystalline polyester (pC4) was 210×0.35:210×0.65+90=24.5:75.5.

The mass ratio of the crystalline polyester (pC4) to the amorphous polyester (p2) in the toner base particles (13) is 89:11. Therefore, the mass ratio of the styrene-(meth)acrylic resin to the polyester is 89×0.245:89×0.755+11=21.8:78.2.

Tables IV and V show the compositions of the toner base particles (1) to (14). Note that in Table IV, the content (solid content equivalent) of each constituent material is expressed in [parts by mass], and in Table V, the content of each constituent component is expressed in [% by mass].

TABLE IV

| | St-Ac | | Crystalline | | Amorphous | | Release | | Release | | Coloring | |
|---|---|---|---|---|---|---|---|---|---|---|---|---|
| Toner | resin | | polyester | | polyester | | agent 1 | | agent 2 | | Agent | |
| base | | parts | | parts | | parts | | parts | | parts | | parts |
| particles | Dispersion | by | Dispersion | by | Dispersion | by | Dispersion | by | Dispersion | by | Dispersion | by |
| No. | Liquid No. | mass | liquid No. | mass | liquid No. | mass | liquid No. | mass | liquid No. | mass | liquid No. | mass |
| 1 | S1 | 1763.0 | — | 0.0 | P1 | 440.8 | S1 | 181.8 | — | 0.0 | Cy1 | 210.0 |
| 2 | S2 | 1322.4 | PC1 | 440.8 | P1 | 440.8 | S2 | 181.8 | — | 0.0 | Cy1 | 210.0 |
| 3 | S3 | 881.6 | PC1 | 881.6 | P1 | 440.8 | S3 | 181.8 | — | 0.0 | Cy1 | 210.0 |
| 4 | S4 | 440.8 | PC1 | 1322.4 | P1 | 440.8 | S4 | 181.8 | — | 0.0 | Cy1 | 210.0 |
| 5 | S5 | 110.2 | PC1 | 1653.0 | P1 | 440.8 | S5 | 0.0 | W2 | 181.8 | Cy1 | 210.0 |
| 6 | S6 | 1322.4 | PC1 | 440.8 | P1 | 440.8 | S6 | 100.5 | — | 0.0 | Cy1 | 210.0 |
| 7 | S2 | 1322.4 | PC2 | 440.8 | P1 | 440.8 | S2 | 181.8 | — | 0.0 | Cy1 | 210.0 |
| 8 | S2 | 1322.4 | PC3 | 440.8 | P1 | 440.8 | S2 | 181.8 | — | 0.0 | Cy1 | 210.0 |
| 9 | S7 | 1763.0 | PC1 | 220.4 | P1 | 220.4 | S7 | 238.8 | — | 0.0 | Cy1 | 210.0 |
| 10 | S8 | 1763.0 | — | 0.0 | P1 | 440.8 | S8 | 181.8 | — | 0.0 | Cy1 | 210.0 |
| 11 | S9 | 1322.4 | PC1 | 440.8 | P1 | 440.8 | S9 | 181.8 | — | 0.0 | Cy1 | 210.0 |
| 12 | S12 | 1542.6 | PC1 | 220.4 | P1 | 440.8 | S12 | 74.6 | — | 0.0 | Cy1 | 210.0 |
| 13 | — | 0.0 | PC4 | 1961.4 | P2 | 242.4 | — | 0.0 | W1 | 181.8 | Cy1 | 210.0 |
| 14 | S10 | 1983.4 | — | 0.0 | P1 | 220.4 | S10 | 181.8 | — | 0.0 | Cy1 | 210.0 |
| 15 | S11 | 1983.4 | PC1 | 110.2 | P1 | 110.2 | S11 | 268.3 | — | 0.0 | Cy1 | 210.0 |

TABLE V

| Toner | St-Ac | | Crystalline | | Amorphous | | Release | | Release | | Coloring | |
|---|---|---|---|---|---|---|---|---|---|---|---|---|
| base | resin | | polyester | | polyester | | agent 1 | | agent 2 | | Agent | |
| particles | Dispersion | % by | Dispersion | % by | Dispersion | % by | Dispersion | % by | Dispersion | % by | Dispersion | % by |
| No. | liquid No. | mass | liquid No. | mass | liquid No. | mass | liquid No. | mass | liquid No. | mass | liquid No. | mass |
| 1 | S1 | 67.92 | — | 0.00 | P1 | 16.98 | S1 | 7.00 | — | 0.00 | Cy1 | 8.10 |
| 2 | S2 | 50.94 | PC1 | 16.98 | P1 | 16.98 | S2 | 7.00 | — | 0.00 | Cy1 | 8.10 |
| 3 | S3 | 33.96 | PC1 | 33.96 | P1 | 16.98 | S3 | 7.00 | — | 0.00 | Cy1 | 8.10 |
| 4 | S4 | 16.98 | PC1 | 50.94 | P1 | 16.98 | S4 | 7.00 | — | 0.00 | Cy1 | 8.10 |
| 5 | S5 | 4.25 | PC1 | 63.68 | P1 | 16.98 | S5 | 0.00 | W2 | 7.00 | Cy1 | 8.10 |
| 6 | S6 | 52.59 | PC1 | 17.53 | P1 | 17.53 | S6 | 4.00 | — | 0.00 | Cy1 | 8.35 |
| 7 | S2 | 50.94 | PC2 | 16.98 | P1 | 16.98 | S2 | 7.00 | — | 0.00 | Cy1 | 8.10 |
| 8 | S2 | 50.94 | PC3 | 16.98 | P1 | 16.98 | S2 | 7.00 | — | 0.00 | Cy1 | 8.10 |
| 9 | S7 | 66.46 | PC1 | 8.31 | P1 | 8.31 | S7 | 9.00 | — | 0.00 | Cy1 | 7.92 |
| 10 | S8 | 67.92 | — | 0.00 | P1 | 16.98 | S8 | 7.00 | — | 0.00 | Cy1 | 8.10 |
| 11 | S9 | 50.94 | PC1 | 16.98 | P1 | 16.98 | S9 | 7.00 | — | 0.00 | Cy1 | 8.10 |
| 12 | S12 | 61.99 | PC1 | 8.86 | P1 | 17.71 | S12 | 3.00 | — | 0.00 | Cy1 | 8.44 |
| 13 | — | 0.00 | PC4 | 75.57 | P2 | 9.34 | — | 0.00 | W1 | 7.00 | Cy1 | 8.09 |
| 14 | S10 | 76.41 | — | 0.00 | P1 | 8.49 | S10 | 7.00 | — | 0.00 | Cy1 | 8.10 |
| 15 | S11 | 73.95 | PC1 | 4.11 | P1 | 4.11 | S11 | 10.00 | — | 0.00 | Cy1 | 7.83 |

### (7) Production of Toner

The following external additives were added to the obtained toner base particles (1) to (15). These mixtures were mixed with a Henschel mixer (manufactured by Mitsuimiikekakouki, Inc.) at a rotor peripheral speed of 35 mm/sec and 32° C. for 20 minutes. After the mixing, coarse particles were removed using a sieve having an opening of 45 μm to obtain toners (1) to (15). Note that the volume-based median diameter of the toner was 6.1 μm.

| | |
|---|---|
| Toner base particles | 100.0 parts by mass |
| Hydrophobic silica particles (number average primary particle size: 12 nm, degree of hydrophobicity: 68) | 0.6 parts by mass |
| Hydrophobic titanium oxide particles (number average primary particle size: 20 nm, degree of | 1.0 part by mass |
| hydrophobicity: 63) | |
| Sol-gel silica (number average primary particle size = 110 nm) | 1.0 part by mass |

### (8) Production of Developer

The obtained toners (1) to (15) and carrier particles were mixed to obtain two-component developers (1) to (15) having a toner particle concentration of 8% by mass. The carrier was particles of ferrite particles coated with acrylic resin and having an average particle size of 3.5 μm.

### 2. Measurement of Loss Tangent (Tan δ) T(70) of Toner

Each of the toners (1) to (15) was weighed to 0.2 g as a measurement sample. Each weighed toner was pressure-molded by a compression molder under pressure of 25 MPa to produce a cylindrical pellet of each toner having a diameter of 10 mm.

As the measuring device, a rheometer “ARES G2” (manufactured by TA Instruments Co., Ltd.) was used. As the plates, a set of disposable plates was used such that a parallel plate having a diameter of 8 mm was arranged at the top and a parallel plate having a diameter of 20 mm was arranged at the bottom. The temperature decrease measurement was performed at 1 Hz frequency. The sample was set at 100° C., and after the gap was once set to 1.4 mm, the sample protruded from between the plates was scraped off. Next, a Gap was set to 1.1 mm, and the temperature was reduced to 30° C. at 10° C./min while applying Axial force, and then held at 30° C. for 30 minutes. Thereafter, the axial force was applied again, the temperature was increased from 30° C. to 150° C. at a rate of 3° C./min, and the temperature increase measurement of the storage elastic modulus (G′) and the loss elastic modulus (G″) was performed. The value of tan δ was calculated from the relationship of (loss elastic modulus/storage elastic modulus) at 70° C. Detailed measurement conditions are shown below.
Frequency: 1 Hz
Ramp rate: 3° C./min
Axicial force: 0 g, sensitivity: 10 g
Initial strain: 3.0%, Strain adjust: 30.0%, Minimum strain: 0.01%, Maximum strain: 10.0%
Minimum torque: 1 g·cm, Maximum torque: 80 g·cm
Sampling interval: 1.0° C./pt
   3. Image formation

The recording media showing below were used. Note that each of all the recording media used was a long medium. The long medium was stored in a state of being wound in a roll shape, and was pulled out from the roll at the time of forming a toner image. Thereafter, when a toner image was formed, the medium was wound again in a roll shape and stored.

### (RM1)

“PYLEN® film P2161” (manufactured by TOYOBO Co., Ltd., thickness: 50 μm, air permeance: 25,000 sec)

### (RM2)

“TOYOBOESTER® FILM E5100” (manufactured by TOYOBO CO., LTD., thickness: 75 μm, air permeance: 23,000 sec)

### (RM3)

“PYLEN® film P2161” (manufactured by TOYOBO Co., Ltd., thickness: 60 μm, air permeance: 26,000 sec)

### (RM4)

“TOYOBOESTER® FILM E5100” (manufactured by TOYOBO CO., LTD., thickness: 50 μm, air permeance: 20,000 sec)

### (RM5)

“S9010N/46 #LF” (manufactured by Avery Dennison Corporation, thickness: 190 μm, air permeance 13,000 sec)

### (RM6)

“NPi Form 45” (manufactured by Nippon Paper Industries, Ltd., thickness: 80 μm, air permeance: 10 sec)

The color label machine “Accurio label 230” (manufactured by Konica Minolta, Inc.) was used as the image forming apparatus. Note that the color label machine was modified so that the surface temperatures of the upper fixing belt and the lower fixing roller and the amount of toner adhesion could be changed. In this image forming apparatus, the recording medium was conveyed into the image forming apparatus from a state of being wound in a roll shape, and was wound again in a roll shape after the toner image was formed.

A 10 cm solid image was output on the recording medium in the same procedure as in the blocking evaluation described later. The obtained image-formed product was directly cut out into a sheet shape without being wound into a roll shape. A 1-cm square sample was further cut out from the cut-out image-formed product, and the cut-out sample was embedded in a photocurable rein. The embedded sample was cut in the thickness direction with a glass knife and a histodiamond knife by microtome to obtain a cut cross section of the image-formed product. A cross-sectional sample of the obtained image-formed product was vertically attached to a sample table of a scanning electron microscopy (SEM), and the cross-section was observed with the SEM at a magnification of 500 times and an acceleration voltage of 0.6 kV. In the cross section, three regions having a width of 200 μm were arbitrarily selected and it was confirmed whether or not a void was present in the regions. Note that the voids were appeared black as compared with the region where the toner was present in the image layer. The case where a void was observed in any of the three arbitrary regions was defined as “presence of void”, and the other case, that is, the case where a void was not observed even in one region was defined as “absence of void”.

### 4. Evaluation

### (1) Blocking

The above developers (1) to (15) were sequentially loaded into the image forming apparatus. A solid image having a toner adhesion amount of 8.0 g/m² was output on the recording medium with the combination of the developer and the recording medium described in Table VI. Note that the temperature (U. O. avoidance temperature +25° C.) that was increased by 25° C. from the temperature at which under offset did not occur (U. O. avoidance temperature) was defined as the temperature of the upper fixing belt, and the temperature of the lower fixing roller was set to 90° C. The fixing speed was set to 230 mm/sec. The image was output on the recording medium in a total of 1,000 m, and the obtained image-formed product was wound into a roll. The roll of the image-formed product was taken out from the winder, and was allowed to stand still with standing up the cylinder for one day. The next day, the image-formed product was pulled out from the roll by 10 m peeling, and it was determined whether or not peeling occurred in the image. Note that the peeling speed was set to a speed of 10 cm/sec. Evaluation was performed according to the following evaluation criteria. Note that the evaluation of C or higher (A to C) was accepted.

### (Evaluation Criteria)

A: No toner peeling occurs in any place, and the toner blocking property is extremely good.
B: Toner peeling occurs in one place, and the toner blocking property is very good.
C: Toner peeling occurs in two places, and the toner blocking property is fairly good.
D: Toner peeling occurs at three or more places, toner blocking occurs, and image failure occurs.
   (2) Fixing property

The above developers (1) to (15) were sequentially loaded into the image forming apparatus. A solid image having a toner adhesion amount of 8.0 g/m² was output on the recording medium with the combination of the developer and the recording medium described in Table VI. A test in which the image was output at a temperature in a range of 130 to 190° C. was performed while the fixing temperature during image formation was changed in increments of 5° C. The lowest fixing temperature at which image contamination due to fixing offset was not visually observed was defined as the lowest fixing temperature, and evaluation was performed according to the following evaluation criteria. Note that the evaluation of C or higher (A to C) was accepted.

### (Evaluation Criteria)

A: The lowest fixing temperature is lower than 130° C., and the low-temperature fixability of the toner is extremely good.
B: The lowest fixing temperature is 130° C. or higher and lower than 150° C., and the low-temperature fixability of the toner is very good.
C: The lowest fixing temperature is 150° C. or higher and lower than 170° C., and the low-temperature fixability of the toner is fairly good.
D: The lowest fixing temperature is 170° C. or higher, the low-temperature fixability of the toner is poor, and the toner is not usable.

### (3) Abrasion Resistance

The above developers (1) to (15) were sequentially loaded into the image forming apparatus. A solid image having a toner adhesion amount of 8.0 g/m² was output on the recording medium with the combination of the developer and the recording medium described in Table VI. Note that the temperature (U. O. avoidance temperature +25° C.) that was increased by 25° C. from the temperature at which under offset did not occur (U. O. avoidance temperature) was defined as the temperature of the upper fixing belt, and the temperature of the lower fixing roller was set to 90° C. The fixing speed was set to 230 mm/sec. The outputted image was subjected to a pencil hardness test with a load of 750 g in accordance with JIS-K5600, and the abrasion resistance of the toner image against a scratching force was evaluated according to the following evaluation criteria. Note that the evaluation of C or higher (A to C) was accepted.

### (Evaluation Criteria)

A: Pencil hardness is 2H or more, and the abrasion resistance of the toner image is extremely good.
B: Pencil hardness is H or more and less than 2H, and the abrasion resistance of the toner image is good.
C: Pencil hardness is HB or more and less than H, and the abrasion resistance of the toner image is good.
D: Pencil hardness is less than HB, the abrasion resistance of the toner is poor, and the toner is not usable.

Table VI shows the results of evaluation and measurement.

TABLE VI

| | Toner | | | | | | | | | | |
|---|---|---|---|---|---|---|---|---|---|---|---|
| | | | | Release | | | | | | | |
| | | | | agent | | Recordingmedium | | | Evaluation | | |
| | | Mass ratio | | [% by | | | Permeability | | | Low-temperature | Abrasion |
| | No. | StAc | PES | mass] | T(70) | No. | [sec] | Void | Blocking | fixability | resistance |
| Example | 1 | 80.0 | 20.0 | 7.00 | 0.70 | RM1 | 25000 | Present | B | B | B |
| 1 | | | | | | | | | | | |
| Example | 2 | 60.0 | 40.0 | 7.00 | 0.60 | RM1 | 25000 | Present | B | B | A |
| 2 | | | | | | | | | | | |
| Example | 3 | 40.0 | 60.0 | 7.00 | 0.40 | RM1 | 25000 | Present | A | B | A |
| 3 | | | | | | | | | | | |
| Example | 4 | 20.0 | 80.0 | 7.00 | 0.30 | RM1 | 25000 | Present | A | A | B |
| 4 | | | | | | | | | | | |
| Example | 5 | 5.0 | 95.0 | 7.00 | 0.20 | RM1 | 25000 | Present | B | A | B |
| 5 | | | | | | | | | | | |
| Example | 6 | 60.0 | 40.0 | 4.00 | 0.55 | RM1 | 25000 | Present | A | B | B |
| 6 | | | | | | | | | | | |
| Example | 7 | 60.0 | 40.0 | 7.00 | 0.20 | RM1 | 25000 | Present | B | A | B |
| 7 | | | | | | | | | | | |
| Example | 8 | 60.0 | 40.0 | 7.00 | 1.20 | RM1 | 25000 | Present | B | C | B |
| 8 | | | | | | | | | | | |
| Example | 9 | 80.0 | 20.0 | 9.00 | 0.70 | RM1 | 25000 | Present | C | B | B |
| 9 | | | | | | | | | | | |
| Example | 10 | 80.0 | 20.0 | 7.00 | 1.80 | RM1 | 25000 | Present | B | C | C |
| 10 | | | | | | | | | | | |
| Example | 11 | 60.0 | 40.0 | 7.00 | 0.70 | RM1 | 25000 | Present | C | B | B |
| 11 | | | | | | | | | | | |
| Example | 3 | 40.0 | 60.0 | 7.00 | 0.40 | RM2 | 23000 | Present | B | B | A |
| 12 | | | | | | | | | | | |
| Example | 12 | 70.0 | 30.0 | 3.00 | 0.45 | RM1 | 25000 | Present | A | B | C |
| 13 | | | | | | | | | | | |
| Example | 3 | 40.0 | 60.0 | 7.00 | 0.40 | RM3 | 26000 | Present | A | B | A |
| 14 | | | | | | | | | | | |
| Example | 3 | 40.0 | 60.0 | 7.00 | 0.40 | RM4 | 20000 | Present | A | B | A |
| 15 | | | | | | | | | | | |
| Example | 13 | 21.8 | 78.2 | 9.00 | 1.50 | RM1 | 25000 | Present | C | C | C |
| 16 | | | | | | | | | | | |
| Comparative | 14 | 90.0 | 10.0 | 7.00 | 0.90 | RM1 | 25000 | Present | D | D | C |
| Example 1 | | | | | | | | | | | |
| Comparative | 2 | 60.0 | 40.0 | 7.00 | 0.60 | RM5 | 13000 | Absent | D | B | B |
| Example 2 | | | | | | | | | | | |
| Comparative | 2 | 60.0 | 40.0 | 7.00 | 0.60 | RM6 | 10 | Absent | D | B | C |
| Example 3 | | | | | | | | | | | |
| Comparative | 15 | 90.0 | 10.0 | 10.00 | 1.00 | RM1 | 25000 | Present | D | B | C |
| Example 4 | | | | | | | | | | | |

From Examples and Comparative Examples, it is found that blocking can be reduced by using the toner of the present embodiment for forming an image on a recording medium that is long and has an air permeance of 20,000 sec or more at a temperature of 25° C. and a pressure of 49.03 hPa. Furthermore, it is found from Examples 3, 12, and 14 that blocking can be further reduced by using the toner of the present embodiment for forming an image on a recording medium that has an air permeance of 25,000 sec or more.

It is found from Examples 4 and 16 that blocking resistance, low-temperature fixability, and abrasion resistance are improved by using the polyester that is not modified with a compound other than the monomer forming the repeating structure in the toner of the present embodiment.

It is found from Examples 2 and 11 that blocking is reduced and abrasion resistance is improved by having a structure derived from methyl methacrylate in the toner of the present embodiment.

It is found from Examples 1 to 5 that the blocking is reduced by having the mass ratio of the styrene-(meth)acrylic resin to the polyester in a range of 60:40 to 5:95 in the toner of the present embodiment.

It is found from Examples 2, 6, 9, and 13 that blocking is reduced by having the content of the release agent of 7% by mass or less with respect to the total mass of the toner base particles in the toner of the present embodiment.

It is found from Examples 5, 7, 8, and 10 that the abrasion resistance is improved by having the loss tangent at 70° C. in a range of 0.2 to 1.2 in the toner of the present embodiment.

Although embodiments of the present invention have been described and illustrated in detail, the disclosed embodiments are made for purposes of illustration and example only and not limitation. The scope of the present invention should be interpreted by terms of the appended claims.

What is claimed is:

1. An electrostatic charge image developing toner comprising toner base particles containing a binder resin, wherein
the binder resin contains a styrene-(meth)acrylic resin and a polyester,
a mass ratio of the styrene-(meth)acrylic resin to the polyester is in a range of 80:20 to 1:99, and
the electrostatic charge image developing toner is used for forming an image on a recording medium that is long and has an air permeance of 20,000 sec or more at a temperature of 25° C. and a pressure of 49.03 hPa.

2. The electrostatic charge image developing toner according to claim 1, wherein
the styrene-(meth)acrylic resin is positioned at an inner side of the toner base particles, and the polyester is positioned at an outer side of the toner base particles.

3. The electrostatic charge image developing toner according to claim 1, wherein the polyester is not modified with a compound other than a monomer that forms a repeating structure.

4. The electrostatic charge image developing toner according to claim 3, wherein the polyester is not modified with the styrene-(meth)acrylic resin.

5. The electrostatic charge image developing toner according to claim 1, wherein the styrene-(meth)acrylic resin has a structure derived from methyl methacrylate.

6. The electrostatic charge image developing toner according to claim 1, wherein a mass ratio of the styrene-(meth)acrylic resin to the polyester is in a range of 60:40 to 5:95.

7. The electrostatic charge image developing toner according to claim 1, wherein a content of a release agent is 7% by mass or less with respect to a total mass of the toner base particles.

8. The electrostatic charge image developing toner according to claim 1, wherein the toner base particles are an emulsion aggregate.

9. The electrostatic charge image developing toner according to claim 1, wherein a loss tangent T(70) at 70° C. determined by a dynamic viscoelasticity measurement is in a range of 0.2 to 1.2.

10. The electrostatic charge image developing toner according to claim 1, wherein the air permeance of the recording medium at a temperature of 25° C. and a pressure of 49.03 hPa is 25,000 sec or more.

11. The electrostatic charge image developing toner according to claim 1, wherein the recording medium contains at least one of polyethylene, polypropylene, and polyethylene terephthalate.

12. A method for producing the electrostatic charge image developing toner according to claim 1, the method comprising:
heating a dispersion liquid of styrene-(meth)acrylic resin particles to a temperature T [° C.] to grow particle size;
mixing the dispersion liquid of styrene-(meth)acrylic resin particles at the temperature T [° C.] with a dispersion liquid of polyester particles while stirring; and
holding the mixed liquid at the temperature T [° C.] for a certain period of time while stirring, wherein
the temperature T [° C.] is higher than a glass transition temperature of the styrene-(meth)acrylic resin by a range of 30 to 40° C.

13. An image forming method comprising
using the electrostatic charge image developing toner according to claim 1 to form an image on a recording medium that is long and has an air permeance of 20,000 sec or more at a temperature of 25° C. and a pressure of 49.03 hPa.

14. An image-formed product, wherein an image layer on a recording medium contains the electrostatic charge image developing toner according to claim 1.

15. The image-formed product according to claim 14, wherein the image layer has at least one void in a region having a width of 200 μm in a cross section in a thickness direction.
